(19) United States
(12) Patent Application Publication
(10) Pub. No.: US 2007/0109990 A1
(43) Pub. Date: May 17, 2007

(54) Pathway parameter exchange between access networks of differing types

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/418,644

(22) Filed: May 5, 2006

Related U.S. Application Data
(63) Continuation-in-part of application No. 11/365,102, filed on Mar. 1, 2006.
(63) Continuation-in-part of application No. 11/394,253, filed on Mar. 30, 2006.
Application No. 11/394,253 is a continuation-in-part of application No. 11/348,632, filed on Feb. 7, 2006.
Application No. 11/394,253 is a continuation-in-part of application No. 11/349,292, filed on Feb. 7, 2006.
Application No. 11/394,253 is a continuation-in-part of application No. 11/365,102, filed on Mar. 1, 2006.
(60) Provisional application No. 60/736,889, filed on Nov. 14, 2005.
(60) Provisional application No. 60/736,889, filed on Nov. 14, 2005.

(51) Int. Cl. H04Q 7/00

(52) U.S. Cl. 370/328; 370/465; 370/351

(57) ABSTRACT

An end-point device comprises multiple communication transceivers via which the end-point device associates with multiple access points. The multiple access points may belong to packet switched data networks that are communicatively incompatible. Each of the associated access points contributes a separate pathway for flow of data packets from the end-point device to a destination device. The end-point device gathers information regarding the associated pathways. The information may contain protocol information, user preferences and/or current pathway performance information. The end-point device uploads unique network addresses assigned to it by the associated access points and the gathered information to all or selected few of nodes of the associated networks. If needed, the end-point device associates with an additional access point or dissociates from an access point. The end-point device keeps the all or the selected few of the nodes updated about its network associations and the currently associated pathway information.

### CROSS-REFERENCE TO RELATED APPLICATIONS/INCORPORATION BY REFERENCE

This application is a continuation-in-part of Utility application Ser. No. 11/365,102, filed on Mar. 1, 2006, which claim priority to Provisional Application Ser. No. 60/736,889, filed on Nov. 14, 2005; and is a continuation-in-part of Utility application Ser. No. 11/394,253, filed on Mar. 30, 2006, which is a continuation-in-part of Utility application Ser. No. 11/348,632, filed on Feb. 7, 2006, a continuation-in-part of Utility application Ser. No. 11/394,292, filed on Feb. 7, 2006, and a continuation-in-part of Utility application Ser. No. 11/365,102, filed on Mar. 1, 2006, and claims priority to Provisional Application Ser. No. 60/736,889, filed on Nov. 14, 2005, all of which are incorporated herein by reference for all purposes.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

1. Field of the Invention

Various aspects of present invention relate to communication by end point devices on a plurality of access networks in an Internet network, and, more particularly, to end point device participation on a plurality of different types of wireless access networks in a packet switched network.

2. Description of the Related Art

A computer, video game box, laptop, phone, PDA (Personal Digital Assistant) and many other types of terminals may be connected to a packet switched data network. Each terminal is typically assigned a unique network address by the packet switched data network. The terminal uses the unique network address to send data packets to and receive data packets from a destination terminal via the packet switched network. The destination terminal may be another computer, laptop, phone, PDA, server, router, switch, access point, or any of a variety of terminals that can handle data packets. The packet switched data network may be, for example, an EDGE (Enhanced Data Rates for GSM Evolution) network, GSM (Global System for Mobile Communications) network, CDMA (Code Division Multiple Access) network, IEEE (Institute of Electrical and Electronics Engineers) 802.11 network, Bluetooth, WiMax network, Internet, Intranet, satellite network, etc. The data typically exchanged between the terminal and the destination terminal may comprise one or combination of text, audio, video, picture and control signal. The data may be real time data or archived data.

The terminal may be associated with more than one access points that belong to the same packet switched data network. Alternately or in addition the terminal may be associated with more than one access points that belong to different packet switched data networks which are communicatively incompatible with each other. The terminal receives unique network addresses from each of the access points. An association of the terminal with an access point is identified by the unique network address assigned by the access point to the terminal. For example the terminal may be associated with a first access point that belongs to an EDGE network, a second access point that belongs to a GSM network and a third access point that belongs to an IEEE 802.11 network. The terminal receives three unique network addresses from the three access points. The terminal may communicate with the destination terminal via the EDGE network or via the GSM network or via the IEEE 802.11 network. In each of the cases the terminal uses the corresponding network address for exchanging data packets. The terminal may also use more than one packet switched data networks to communicate with destination terminal.

The first access point that belongs to an EDGE network is unaware of association of the terminal with other access points and/or other packet switched data networks. Similarly the second access point that belongs to the GSM network is oblivious of the communication capability of the terminal with the destination terminal via the EDGE network and the IEEE 802.11 network.

Further limitations and disadvantages of conventional and traditional approaches will become apparent to one of ordinary skill in the art through comparison of such systems with various aspects of the present invention.

### BRIEF SUMMARY OF THE INVENTION

A device that interacts with a variety of communication data networks via a plurality of pathways and controls exchange of pathway information between the variety of communication data networks, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF THE DRAWINGS

For various aspects of the present invention to be easily understood and readily practiced, various aspects will now be described, for purposes of illustration and not limitation, in conjunction with the following figures:

FIG. 1 is a schematic block diagram illustrating interaction between a plurality of client devices and an Internet backbone via a plurality of access points, each of the plurality of client devices interacting with more than one access point in accordance with various aspects of the present invention;

FIG. 2 is a schematic block diagram illustrating storage of network association information corresponding to a client device of FIG. 1 in the client device and in the plurality of access points with which the client device interacts;

FIG. 3 is a schematic block diagram illustrating a plurality of components of a client device of FIG. 1, the client device supporting a plurality of packet data paths from the client device to the plurality of access points of FIG. 1;

FIG. 4 is a schematic block diagram illustrating a plurality of components of an access point of FIG. 1, the access point supporting a plurality of packet switched data paths from the access point to the Internet backbone;

FIG. 5 is a schematic that shows a mobile client device moving from coverage area of a first access point to coverage area of a second access point;

FIG. 6 is a flow chart illustrating a method of collecting information corresponding to a plurality of network associations of a client device by the client device;

FIG. 7 is a flow chart illustrating functions performed by a client device that supports a plurality of network associations in accordance with the present invention; and

FIG. 8 is a schematic block diagram illustrating storage of a plurality of network addresses in each of a plurality of access points that interact with a plurality of end point devices.

### DETAILED DESCRIPTION

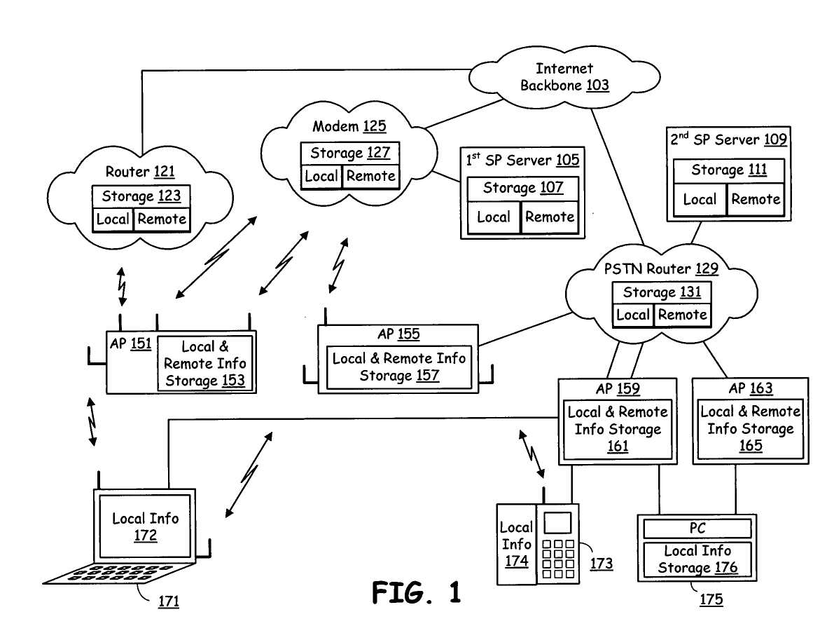

FIG. 1 is a schematic block diagram illustrating interaction between a plurality of client devices 171, 173 and 175 and an Internet backbone 103 via a plurality of access points 151, 155, 159 and 163, each of the plurality of client devices 171, 173 and 175 interacting with more than one access point. A laptop 171 is communicatively coupled to AP (access point) 151, AP 155 and AP 159. The laptop 171 is connected to the AP 151 and the AP 155 via wireless links. The laptop 171 is connected to the AP 159 via wired link. A PDA 173 is communicatively connected to the AP 155 over wireless link and communicatively coupled to the AP 159 via wired link. A PC (personal computer) 175 is communicatively connected to the AP 159 and AP 163 via wired links. The laptop 171, the PDA 173 and the PC 175 (the plurality of client devices) comprise upstream communication interfaces via which the laptop 171, the PDA 173 and the PC 175 receive and send data packets to associated access points 151, 155, 159, and 163. In this non-limiting example the laptop 171 has two upstream wireless interfaces and one upstream wired interface, the PDA 173 has one upstream wireless interface and one upstream wired interface and the PC 175 has two upstream wired interfaces.

The access points 151, 155, 159, and 163 comprise upstream and downstream interfaces. The access points 151, 155, 159, and 163 communicate with the plurality of client devices (the laptop 171, the PDA 173 and the PC 175) via downstream interfaces and communicate with nodes of packet switched data networks via upstream interfaces. The nodes of the packet switched data networks refer to modems, routers, switches, hubs and/or servers belonging to the packet switched data networks. In this example the AP 151 comprises three upstream wireless interfaces and one downstream wireless interface. The AP 151 communicates with a WiMax router 121 using a first upstream wireless interface, communicates with an IEEE 802.11 modem 125 using a second upstream wireless interface and a third upstream wireless interface, and communicates with the laptop 171 via the one downstream wireless interface. The AP 151 has a single upstream pathway to the WiMax router 121, two upstream pathways to the IEEE 802.11 modem 125 and one downstream pathway to the laptop 171.

As used herein, “upstream pathway” and “downstream pathway” do not refer to actual direction of data flow. Instead, “upstream pathway” refers to a pathway from the present device that communicatively couples with the Internet backbone 103, while “downstream pathway” refers to a pathway from the present device toward an end-point device. The AP 155 has an upstream wireless pathway to the IEEE 802.11 modem 125, an upstream wired pathway to a PSTN router 129, a first downstream pathway to the laptop 171 and a second downstream pathway to the PDA 173. The AP 159 has two upstream wired pathways to the PSTN router 129 and three downstream wired pathways respectively to the laptop 171, the PDA 173 and the PC 175. The AP 163 communicates with the PSTN router 129 and the PC 175. Each of the plurality of access points 151, 155, 159, and 163 may be communicatively coupled to same or different upstream nodes. Each of the plurality of access points 151, 155, 159, and 163 may be communicatively coupled to same or different downstream client devices.

The WiMax router 121, the IEEE 802.11 modem 125, and the PSTN router 129 are communicatively connected to the Internet backbone 103. In this example a first service provider (SP) provides the WiMax service and the IEEE 802.11 service. The WiMax router 121 and the IEEE 802.11 modem 125 communicate with a first service provider server 105. The PSTN router 129 communicates with a second service provider server 109, where PSTN service is provided by the second service provider (SP).

The laptop 171 has three unique Internet Protocol addresses (network addresses) assigned by access points with which the laptop 171 is associated. A first IP (Internet Protocol) address is assigned to the laptop 171 by the AP 151. The laptop 171 receives and sends data packets to the AP 151 using the first IP address. The AP 151 uses a second IP address to communicate with the laptop 171. Association of the laptop 171 with the AP 151 is identified by the first IP address of the laptop 151 and the second IP address of the AP 151. Similarly a third IP address is assigned to the laptop 171 by the AP 155. The AP 155 uses a fourth IP address to interact with the laptop 171. Association of the laptop 171 with the AP 159 is identified by a fifth IP address assigned to the laptop 171 by the AP 159 and a sixth IP address used by the AP 159 to communicate with the laptop 171.

The PDA 173 has two unique IP addresses, a seventh IP address assigned by the AP 155 and a eighth IP address assigned by the AP 159. The PC 175 has two more unique IP addresses, a ninth IP address assigned by the AP 159 and a tenth IP address assigned by the AP 163.

As an example, the laptop 171 desires to send data packets (i.e., data) to a destination device. As used herein, “client device,” “end-point device”, “destination device” refer to any of a variety of devices that can handle data packets. The data packets from the laptop 171 travel to the Internet backbone 103 and from there travel to the destination device. The laptop 171 has a plurality of communication pathways to the Internet backbone 103 via which the data packets may travel to the Internet backbone 103. A first pathway from the laptop 171 to the Internet backbone 103 comprises a first wireless link between the laptop 171 and the AP 151, the AP 151, a wireless link between the AP 151 and the WiMax router 121, a wired link between the WiMax router 121 and the Internet backbone 103. A second pathway from the laptop 171 to the Internet backbone 103 comprises a second wireless link between the laptop 171 and the AP 155, the AP 155, a wireless link between the AP 155 and the IEEE 802.11 modem 125, a wired link between the IEEE 802.11 modem 125 and the Internet backbone 103 and the Internet backbone 103. A third pathway from the laptop 171 to the Internet backbone 103 comprises a third wired link between the laptop 171 and the AP 159, the AP 159, a wired link between the AP 159 and the PSTN router 129, a wired link between the PSTN router 129 and the Internet backbone 103 and the Internet backbone 103. There are additional pathways from the laptop 171 to the Internet backbone 103; the additional pathways are not disjoint with the first pathway, the second pathway, and the third pathway.

The laptop 171 collects a plurality of parameters corresponding to each of the first pathway, the second pathway, and the third pathway and stores the plurality of parameters in a memory 172 of the laptop 171. The plurality of parameters associated with the first pathway includes the first IP address assigned by the AP 151, protocol related parameters, current performance related parameters and user-defined parameters. As example, the protocol related parameters may comprise a protocol identifier, version number, maximum data rate supported by the protocol, security information, QoS provided by the protocol etc. The first pathway in this example uses WiMax protocol. The protocol related parameters associated with the first pathway may comprise version number of the WiMax protocol, maximum data rate supported by the WiMax protocol of aforesaid version, encryption/decryption required for exchange of data packets using the WiMax protocol, security and QoS provided by the WiMax protocol, minimum bandwidth requirement of the WiMax protocol etc. The protocol related parameters may additionally indicate if the protocol is a proprietary or industry standard protocol. The protocol related parameters associated with the third pathway, that comprises the PSTN router 129, may comprise maximum data rate supported by PSTN, encryption/decryption required for exchange of data packets via the PSTN, security and QoS provided by the PSTN, minimum bandwidth requirement of the PSTN etc. As an example the protocol related parameters associated with the third pathway may indicate that the third pathway may be used for transporting voice data but may not support video streaming. The protocol related parameters associated with each of the first pathway, the second pathway and the third pathway may suggest that the first pathway is best among the three pathways from the laptop 171 to the Internet backbone 103 for carrying out video streaming.

Some or all of the protocol related parameters associated with each of the three pathways from the laptop 171 to the Internet backbone 103 may be hardwired into the memory 172 of the laptop 171 by manufacturer. Some or all of the protocol related parameters may be received by the laptop 171 from the AP 151 when the laptop 171 associates with the AP 151 and subsequently stored in the memory 172. In another embodiment at least some of the protocol related parameters associated with each of the three pathways is received by the laptop 171 from any of network nodes, including the AP 151, the AP 155 and the AP 159, along the first pathway, along the second pathway and the third pathway respectively.

The current performance related parameters associated with the first pathway may comprise current traffic load on the first wireless link between the laptop 171 and the AP 151, noise and/or interference level in the first wireless link, cost of the first wireless link etc. There may not be any data packets moving through the first wireless link at an instant of time. The current traffic load at the instant of time is zero. At a second instant of time the first wireless link may be carrying a high volume of data packets and as a consequence the current traffic load as well as the noise level in the first wireless link at the second instant of time increases. The current performance related parameters associated with the second pathway may similarly comprise current traffic load on the second wireless link between the laptop 171 and the AP 155, noise and/or interference level in the second wireless link, cost of the second wireless link etc. The laptop 171 may evaluate the current performance related parameters associated with each of the three pathways using a processing circuitry of the laptop 171 and/or may receive some or all of the current performance related parameters from the respective access points, i.e., AP 151, AP 153 and AP 159. The laptop 171 may be alternately or in addition adapted to receive some or all of the current performance related parameters associated with each of the three pathways from any network node along the respective pathways.

The laptop 171 comprises a user input interface. The user input interface may typically be a plurality of buttons, a mouse, a touch screen, a touchpad, a thumbwheel etc. A user may enter one or more preferences using the user input interface. The user-defined parameters (preferences) may include a pathway priority setting. For example the user may assign highest priority to the second pathway. Whenever a communication application (for e.g., Internet browsing application, video gaming application, Internet telephony application, file downloading application etc.) running on the laptop 171 requires transmission or reception of packet data from the destination device, the laptop 171 tries to use the second pathway for transmission or reception of packet data. If communication via the second pathway fails, then the laptop 171 tries to use remaining available pathways for data communication. The user-defined parameters may additionally include bandwidth and data rate setting. The user may set a minimum desirable downstream data rate using the user input interface. Whenever the communication application running on the laptop 171 asks for transmission or reception of packet data from the destination device, the laptop 171 uses that pathway from the three pathways that satisfies the minimum desirable downstream data rate set by the user. The access points AP 151, AP 155, and AP 159 may assist the laptop 171 in selecting a pathway from the three pathways as per the user-defined parameters associated with the three pathways. The user-defined parameters may also include user information that may be required while billing the user for using one or more of the three pathways for data communication. The laptop 171 stores the user-defined parameters in the memory 172 of the laptop 171.

The memory 172 of the laptop 171 has the first IP address assigned by the AP 151, the protocol related parameters, the current performance related parameters and the user-defined parameters associated with the first pathway stored in it. The memory 172 of the laptop also has the third IP address assigned by the AP 155, the protocol related parameters, and the current performance related parameters and user-defined parameters associated with the second pathway stored in it. Information associated with the third pathway is also stored in the memory 172 of the laptop 171. All these information are referred to as local information of the laptop 171. The PDA 173 and the PC 175 have respective local information stored in memories 174 and 176 respectively.

The AP 151 is aware of the first IP address assigned by the AP 151 to the laptop 171. The AP 151 may be aware of some or all of the remaining plurality of parameters (i.e., the protocol related parameters, the current performance related parameters and user-defined parameters) associated with the first pathway. The laptop 171 transmits the plurality of parameters associated with the first pathway to the AP 151 using the first pathway. In addition the laptop 171 transmits the plurality of parameters associated with the second pathway and the plurality of parameters associated with the third pathway to the AP 151 using the first pathway. The first AP 151 is thus made aware of IP address, protocol related parameters, current performance related parameters and user-defined parameters associated with the first pathway, the second pathway and the third pathway between the laptop 171 and the Internet backbone 103. The AP 151 receives and stores the plurality of parameters associated with each of the three pathways between the laptop 171 and the Internet backbone 103 in a storage unit 153.

The laptop 171 is associated with the AP 155 via the second pathway. The laptop 171 transmits the plurality of parameters associated with the first pathway, the second pathway, and the third pathway to the AP 155 using the second pathway. The AP 155 is thus made aware of all network associations of the laptop 171 and corresponding plurality of parameters. Similarly the AP 159 is made aware of all the network associations of the laptop 171 and corresponding plurality of parameters (i.e., the IP address, the protocol related parameters, the current performance related parameters and user-defined parameters). The AP 155 and the AP 159 store the plurality of parameters received from the laptop 171 respectively in storage units 157 and 161. The plurality of parameters, associated with all the network associations of the laptop 171, that are received by each of the AP 151, the AP 155 and the AP 159 from the laptop 171 are referred to as remote parameters of respective access points.

The PDA 173 has two network associations; the PDA 173 is associated with the AP 155 and the AP 159. The PDA 173 has a plurality of pathways to the Internet backbone 103, one of the plurality of pathways via the AP 155 and the IEEE 802.11 modem 125 and another via the AP 159 and the PSTN router 129. These two pathways are disjoint with each other. Additional pathways between the PDA 173 and the Internet backbone 103 have one or more links common with theses two pathways. The PDA 173 collects and stores the plurality of parameters associated with these two pathways in the memory 174 of the PDA 173. The PDA 173 sends the plurality of parameters associated with these two pathways to each of the AP 155 and the AP 159. The AP 155 and the AP 159 store the received parameters in respective storage units 157 and 161. The received parameters are referred to as remote parameters of the AP 155 and the AP 159 respectively.

The AP 151 has three upstream pathways to the Internet backbone 103, a first one via the WiMax router 121, a second one via the IEEE 802.11 modem and a third one again via the IEEE 802.11 modem. The AP 151 may collect a plurality of parameters related to the three upstream pathways and store them in the storage unit 153. The plurality of parameters related to the three upstream pathways may comprise current performance parameters associated with the three upstream pathways, as for example and without limitation, cost of the three upstream pathways, traffic load, latency, noise and interference level in the three upstream pathways etc. The plurality of parameters related to the three upstream pathways originating from the AP 151 are referred to as local parameters of the AP 151. In addition the AP 151 stores IP addresses of the AP 151 that the AP 151 uses to communicate to upstream network nodes (i.e., the WiMax router 121, the IEEE 802.11 modem 125) and downstream client device (i.e., the laptop 171). Each of the AP 155, the AP 159, and the AP 163 has one or more pathways to the Internet backbone 103. Each of the AP 155, the AP 159 and the AP 163 may collect current performance parameters associated with links between the AP and next immediate upstream network node and store the collected parameters in the respective storage units 157, 161 and 165.

Each of the client devices (i.e., the laptop 171, the PDA 173 and the PC 175) has more than one upstream pathway to the Internet backbone 103. The plurality of parameters associated with each of available upstream pathways is stored in each network node along respective upstream pathway. As an example, the upstream first pathway from the laptop 171 to the Internet backbone 103 comprises the first wireless link between the laptop 171 and the AP 151, the AP 151, the wireless link between the AP 151 and the WiMax router 121, the wired link between the WiMax router 121 and the Internet backbone 103 and the Internet backbone 103. The first IP address assigned by the AP 151 to the laptop 171, the protocol related parameters, the user-defined parameters and the current performance related parameters associated with the first wireless link between the laptop 171 and the AP 151 (the next immediate upstream network node) are stored in the memory 172 of the laptop 171 in the name of local information, in the storage unit 153 of the AP 151 in the name of remote information, in a storage unit 123 of the WiMax router 121 in the name of remote information and in a storage unit 107 of the first service provider server 105. Some or all of network nodes except the client devices (the laptop 171, the PDA 173 and the PC 175) may gather network related parameters associated with communication links between the network nodes and next immediate upstream network nodes. The network nodes store gathered parameters in respective storage units.

Network associations of each of the client devices (i.e., the laptop 171, the PDA 173 and the PC 175) may change with time. Network associations may change due to movement of the client devices and/or failure of an existing communication pathway. As an example and without limitation, the first upstream pathway between the laptop 171 and the Internet backbone 103 may fail at an instant of time. The laptop 171 subsequently sends only the plurality of parameters associated with the second upstream pathway and the plurality of parameters associated with the third upstream pathway to each of the AP 155 and the AP 159. The AP 155 and the AP 159 are thus made aware of nonexistence of the first upstream pathway.

The plurality of parameters associated with any of upstream pathways may change with time. As an example and without limitation, at an instant of time the user using the laptop enters a user preference for minimum desirable data rate via the user input interface of the laptop 171. Subsequently the laptop 171 informs the user preference to the AP 151, the AP 155, and the AP 159. As another example, traffic load on the wireless link between the laptop 171 and the AP 151 decreases at a second instant of time. Subsequently the laptop 171 sends the updated traffic load parameter associated with the first pathway to the AP 151, the AP 155, and the AP 159. Each of the client devices (i.e., the laptop 171, the PDA 173 and the PC 175) may update the plurality of parameters associated with each of corresponding network associations at regular intervals and transmit updated plurality of parameters to all associated access points.

The AP 155 is associated with the laptop 171 and the PDA 173. The AP 155 is aware of all network associations of the laptop 171 and plurality of parameters associated with pathways between the laptop 171 and the Internet backbone 103. The AP 155 is in addition aware of all network associations of the PDA 173 and plurality of parameters associated with pathways between the PDA 173 and the Internet backbone 103.

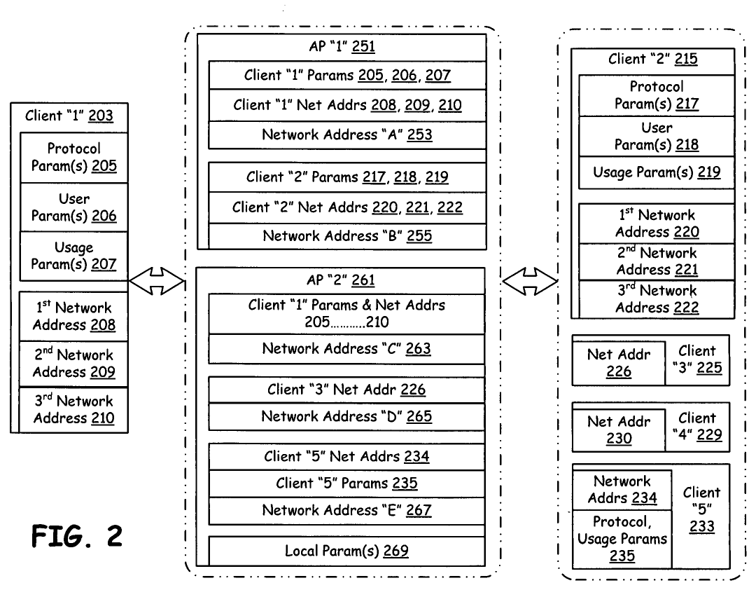

FIG. 2 is a schematic block diagram illustrating storage of network association information corresponding to a client device 171 (or 173) of FIG. 1 in the client device 203 (or 215) and in the plurality of access points 251 and 261 (or 251 and 261) with which the client device 203 (or 215) interacts. Each of client devices in this exemplary case may be a phone, a laptop, a PDA, a PC, a video game box, an Internet server, an Intranet server etc. In this exemplary case 203 is identified as a first client device, 215 is identified as a second client device, 225 is identified as a third client device, 229 is identified as a fourth client device and 233 is identified as a fifth client device. All 203, 215, 225, 229 are 233 are devices that are adapted to support packet data transmission and reception. At least one communication application for example, an Internet browsing application, an Internet telephony application, a video gaming application, a music video downloading application, a file downloading application etc. is running on each of the client devices and the at least one communication application calls for exchange of packet data with another of the client devices.

The first client device 203 is associated with three access points. Each of the three access points assigns unique network address to the client device 203. Each of the three access points are transceivers that receive packet data from the client device 203 and forward the received packet data to one or more upstream communicatively connected network nodes. Network nodes typically refer to routers, switches, modems, and hubs etc. that participate in transporting the packet data along a pathway from a client device to an Internet backbone. A first AP 251 and a second AP 261 are two of the three access points to which the first client device 203 is associated. The first AP 251 assigns a first network address 208 to the first client device 203. The first AP 251 uses another unique network address “A” 253 whenever the first AP 251 communicates (i.e., sends or receives data packets or control data packets etc.) with the first client device 203. The first AP 251 stores the network address “A” 253 in a memory of the first access point 251. If the first client device 203 and the first AP 251 use Internet protocol to exchange data packets then the first network address 208 and the network address “A” 253 refer to IP (Internet Protocol) addresses. Association of the first client device 203 with the first AP 251 is identified by two unique network addresses; the first network address 208 and the network address “A” 253.

Association of the first client device 203 with the second access point 261 is identified by two more unique network addresses, the second network address 209 and the network address “C” 263. Association of the first client device 203 with a third access point, not shown in the FIG. 2, is identified by the third network address 210 and a network address stored in the third AP. The first client device 203 stores the first network address 208, the second network address 209 and the third network address 210 in a memory of the first client device 203. The second AP 261 stores the network address “C” 263 in a memory of the second access point 261.

The first client device 203 stores protocol related parameters 205, user-defined parameters 206 and usage parameters 207 in the memory of the first client device 203. The first access point 251 and the second access point 261 may belong to heterogeneous packet switched data networks. As an example, the first access point 251 may belong to IEEE 802.11 network and the second access point 261 may belong to cable data network. The first client device 203 follows IEEE 802.11 protocol when it communicates with the first access point 251 and follows DOCSIS protocol when it communicates with the second access point 261. The protocol related parameters 205 comprise capabilities and limitations of protocols that are used by the first client device 203 to communicate with associated access points. The protocol related parameters 205 may include maximum data rate supported, encryption/decryption required for data packet exchange, security and QoS supported, minimum bandwidth requirement, minimum signal-to-noise level requirement, minimum transmitted power requirement, etc. of each of the IEEE 802.11 protocol and the DOCSIS protocol. The protocol related parameters may be acquired by the first client device 203 from the first AP 251 when the first client device 203 receives the first network address from the first AP 251.

The first client device comprises a user input interface. A user operating the first client device 203 may enter user selection via the user input interface. The user selection may include a minimum download data speed requirement, a maximum cost requirement etc. The user-defined parameters 206 include the user selection entered via the user input interface. The first client device 203 uses the user-defined parameters 206 when it selects a network association from the three available network associations (i.e., the association with the three access points) for transporting packet data. In one embodiment, one or more of the three associated access points instead of the first client device 203 may select the network association from the three available network associations for transporting packet data. In the one embodiment the one or more of the three associated access points uses the user-defined parameters 206 while selecting the network association.

The usage parameters 207 associated with the first client device 203 may include current performance measure of communication links between the first client device 203 and the currently associated three access points. Communication link between the first client device 203 and the first AP 251 that belongs to the IEEE 802.11 network is a wireless link and communication link between the first client device 203 and the second AP 261 that belongs to the cable data network is a wired link. The usage parameters 207 at a first instant of time, for example, may comprise current traffic load on the wireless link, noise and/or interference level in the wireless link, delay in the wireless link, cost of the wireless link etc. The usage parameters 207 at the first instant of time in addition comprises current traffic load on the wired link, noise and/or interference level in the wired link, delay in the wired link, cost of the wired link etc. The first client device 203 may be adapted to independently measure the usage parameters 207 corresponding to the communication links between the first client device 203 and the currently associated three access points. In another embodiment the first client device 203 may receive some or all of the usage parameters 207 from respective associated access points.

The first client device 203 transmits the protocol related parameters 205, the user-defined parameters 206, the usage parameters 207, the first network address 208, the second network address 209, and the third network address 210 to the first AP 251. The first AP 251 is thus made aware of network addresses assigned by other two access points (for e.g., 261) to the first client device 203, the limitations and the capabilities of the protocols used by the first client device 203 to interact with the other access points, current performance of communication links between the first client device 203 and the other access points. The first client device 203 also transmits all above information to the second AP 261 and the third AP (not shown in the FIG. 2). The second AP 261 and the third AP are thus aware of all network associations and related performance parameters of the first client device 203. The first AP 251, the second AP 261 and the third AP store all information (i.e., parameters and network addresses) received from the first access point 203 in respective memories of the first AP 251, the second AP 261 and the third AP.

Network associations of the first client device 203 may change with time. As an example at a second instant of time the first client device 203 may move to a different location that is outside service area of the third AP. The first client device 203 no longer remains associated with the third AP. The first client device 203 remains associated with the first AP 251 and the second AP 261 from the second instant of time onwards. The first client device 203 removes the third network address 210 assigned by the third AP from the memory of the first client device 203. The first client device informs the first AP 251 and the second AP 261 about dissociation from the third AP. The first AP 251 and the second AP 261 subsequently remove the third network address 210, protocol related parameters and user-defined parameters corresponding to the third AP from respective memories.

In another embodiment after disassociating from the third AP, the first client device 203 transmits the first network address 208, the second network address 209, an updated protocol related parameters and an updated usage parameters to each of the first AP 251 and the second AP 261. The updated protocol related parameters comprise information about the capabilities and limitations of the IEEE 802.11 protocol and DOCSIS protocol (i.e., protocols used by the first AP 251 and the second AP 261) and the updated usage parameters comprise performance measure of communication links between the first client device 203 and the first AP 251 and between the first client device 203 and the second AP 261 (i.e., currently associated access points). The first AP 251 and the second AP 261 replace the stored network information (i.e., network addresses and various parameters) corresponding to the first client device 203 with most recently received updated network information.

The first client device 203 may be adapted to respond to a change in any of the network information (i.e., network addresses and various parameters) by acquiring updated network information, replacing stored network information in the memory of the first client device 203 with the updated network information and transmitting the updated network information to each of currently associated access points. The first client device 203 may be in addition and/or alternately adapted to acquire network information at regular intervals and send regularly acquired network information to each of the currently associated access points.

The first AP 251 at an instant of time is associated with the first client device 203 and the second client device 215. The first AP receives network addresses 208, 209 and 210 of the first client device 203 from the first client device 203 and stores the received network addresses in the memory of the first AP 251. The first AP 251 receives parameters 205, 206, and 207 associated with first client device 203 from the first client device 203 and stores the received parameters in the memory of the first AP 251. The first AP in addition receives network addresses 220, 221 and 222 of the second client device 215 from the second client device 215 and stores the received network addresses in the memory of the first AP 251. The first AP 251 also receives parameters 217, 218, and 219 associated with second client device 215 from the second client device 215 and stores the received parameters in the memory of the first AP 251. The first AP 251 is aware of all network associations and related parameters of each of client devices to which the first AP 251 is communicatively connected at the instant of time.

The second AP 261 at the instant of time is communicatively connected (i.e., associated) to the first client device 203, the third client device 225 and the fifth client device 233. The second AP 261 receives and stores all network addresses of the first client device 203 i.e., 208, 209 and 210, and parameters 205, 206 and 207 associated with the first client device 203. The second AP 261 stores the network address “C” 263 that the second AP 261 uses to communicate with the first client device 203. The third client device 225 at the instant of time is associated with only the second AP 261. The second AP 261 receives and stores single network address 226 of the third client device 225. Since the third client device 225 maintains only one network association, the third client device 225 in the present embodiment does not collect and/or store protocol related parameters, user-defined parameters and usage parameters associated with the only one network association. The second AP 261 stores the network address “D” 265 that the second AP 261 uses to communicate with the third client device 225. The second AP 261 receives and stores all network addresses 234 of the fifth client device 233 and parameters 235 associated with the fifth client device 233. The second AP 261 stores the network address “E” 267 that the second AP 261 uses to communicate with the fifth client device 233. The second AP 261 is aware of all network associations and related parameters of each of client devices to which the second AP 261 is communicatively connected at the instant of time.

A change in network associations and/or a change in any of the various parameters i.e., the protocol related parameters, the user-defined parameters and the usage parameters corresponding to the client devices, 203, 215, 225, 229 and 233, is reflected in the memories (i.e., storage units) of associated access points.

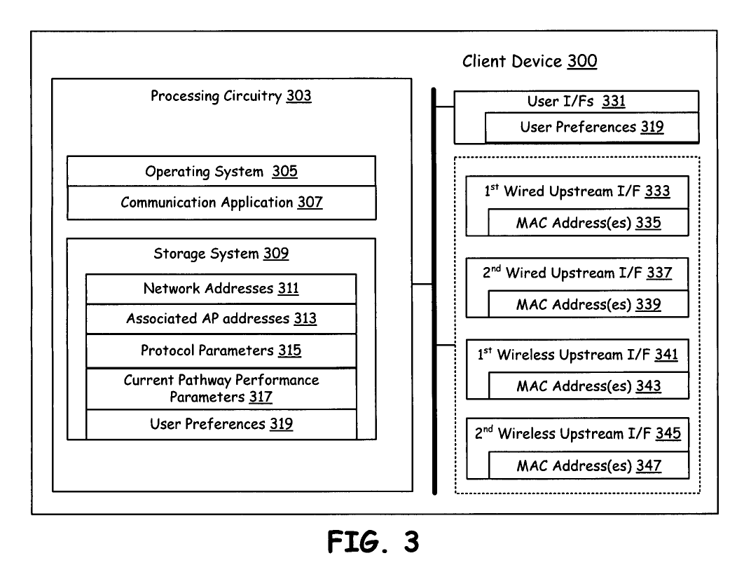

FIG. 3 is a schematic block diagram illustrating a plurality of components of a client device 171 of FIG. 1, the client device 171 supporting a plurality of packet data paths from the client device 171 to the plurality of access points 151, 155 and 159 of FIG. 1. The client device 300 comprises a processing circuitry 303, a storage system 309, a user input interface 331, a first wired upstream interface 333, a second wired upstream interface 337, a first wireless upstream interface 341, and a second wireless upstream interface 345. Each of the wired and wireless interfaces (333, 337, 341, and 345) interacts with at least a corresponding hardware device, and the corresponding hardware device is uniquely identified by a medium access control (MAC) address. The corresponding hardware device typically comprises a transceiver. The transceiver is used to send and receive data (i.e., packet data). An operating system 305, which is software, runs on the client device 300. A communication application 307 runs on the client device 300. The communication application 307 may be for example a Web browsing application, a video game application, an archived data download application, an Internet telephony application etc. The communication application 307 may call for archived data transfer and/or real time data transfer. Depending on type of the communication application 307 running on the client device 300, the client device 300 may need a high bandwidth, low latency communication pathway from the client device 300 to Internet backbone or may need a high latency, low bandwidth communication pathway or a combination of these two extremes.

The client device 300, on power on, associates itself with all available packet switched communication networks. All the available packet switched communication networks are communicatively connected to the Internet backbone. The client device 300 comprises four communication interfaces (333, 337, 341, and 345) and the client device 300 is able to associate itself with a maximum of four packet switched communication (data) networks of similar or communicatively incompatible types. For example and without limitation, the client device 300, one power on, associates itself with a first access point of a cable data network via the first wired upstream interface 333. Association with the first access point of the cable data network includes allocation of a first IP address by the first access point to the client device 300. The client device 300 uses the first IP address and the first wired upstream interface 333 to send data to the cable data network (and/or the Internet backbone) and receive data from the cable data network (and/or the Internet backbone) via the first access point. The association of the client device 300 with the first access point opens up a first pathway between the client device 300 and the Internet backbone. The first pathway in the example comprises a first wired link between the client device 300 and the first access point, the first access point, a communication link between the first access point and Internet backbone via one or more nodes belonging to the cable data network.

In this non-limiting example the client device 300 associates with a second access point of a fiber optic data network via the second wired upstream interface 337 and a second IP address. The second IP address is allocated to the client device 300 by the second access point (i.e., the fiber optic data network). A second pathway between the client device 300 and the Internet backbone is thus set up. A second wired link between the client device 300 and the second access point is part of the second pathway.

The client device 300 further associates with a third access point that belongs to a satellite data network via the first wireless upstream interface 341 and a third IP address. A third pathway between the client device 300 and the Internet backbone is thus set up. A first wireless link between the client device 300 and the third access point is part of the third pathway. The client device 300 additionally associates itself with a fourth access point that belongs to a UMTS data network via the second wireless upstream interface 345 and a fourth IP address. A second wireless link between the client device 300 and the fourth access point, the fourth access point, a communication link between the fourth access point and the Internet backbone via one or mode of network nodes that belong to the UMTS network constitute a fourth pathway between the client device 300 and the Internet backbone. The third IP address and the fourth IP address are assigned to the client device 300 by the third access point (i.e., the satellite data network) and the fourth access point (i.e., the UMTS network) respectively. The client device 300 has four pathways from the client device 300 to the Internet backbone. Each of the four pathways supports packet data communication between the client device 300 and the Internet backbone. In the example the client device 300 associates itself with four communicatively incompatible packet switched data networks, i.e., the cable data network, the fiber optic data network, the satellite data network, and the UMTS network.

The user input interface 331 of the client device 300 may be a plurality of buttons, a keyboard, a touch screen, a mouse, a voice based interface, a pen, a touchpad, a thumbwheel etc. The client device 300 may a personal computer, a phone, a laptop, a television, a PDA, a video game box etc. If client device 300 is a personal computer then the user input interface 331 is typically a mouse and a keyboard. If the client device 300 is a phone then the user input interface 331 is typically a screen and a plurality of buttons. If the client device 300 is a video game box then the user input interface 331 is typically a thumbwheel and a game pad.

As a way of example the client device 300 is a phone. The phone 300 upon association with four access points, the first AP (access point), the second AP, the third AP and the fourth AP stores the first IP address, the second IP address, the third IP address and the fourth IP address assigned by respective access points, together referred to as network addresses 311 of the phone 300, in the storage system 309 of the phone 300. The four access points use unique four different IP addresses (i.e., network addresses) for communicating with the phone 300. The phone 300 stores the four different IP addresses of the four access points 313 in the storage system 309. The phone 300 collects protocol parameters 315 associated with the four pathways and stores in the storage system 309. The phone 300 further collects current pathway performance parameters 317 corresponding to the four pathways and stores in the storage system 309. The phone 300 in addition receives user preferences 319 entered by a user via the plurality of buttons 331 (the user input interface of the phone 300) and stores in the storage system 309.

The protocol parameters 315 associated with the four pathways may comprise bandwidth requirements, maximum data rate limitations, security information, quality of service information, encryption and/or decryption requirement, robustness against eavesdropping etc. associated with protocols used in the four pathways. In the example the phone 300 communicates with the first access point using a first protocol that is supported by the cable data network (for e.g., Ethernet protocol). The phone 300 communicates with the second access point, the third access point and the fourth access point using respectively a second protocol that is supported by the fiber optic data network (for e.g., FDDI protocol), a third protocol that is supported by the satellite data network (for e.g., TCP/IP with some modifications in MAC layer) and a fourth protocol that is supported by the UMTS network (for e.g., W-CDMA for the air-interface). The four protocols, the first protocol, the second protocol, the third protocol, and the fourth protocol are communicatively incompatible with each other. The protocol parameters 315 associated with the four pathways may comprise bandwidth requirement of each of the four protocols, maximum upstream and downstream data rate supported by each of the four protocols, level of security supported by each of the four protocols, quality of service provided by each of the four protocols where quality of service may include latency and bit error vs. signal-to-noise performance of a protocol, encryption and/or decryption (if any) required by each of the four protocols, transmit power requirement for each of the four protocols. The protocol parameters 315 may also indicate how robust the four protocols are against eavesdropping, version number of the four protocols, type of the four protocols, i.e., whether the four protocols are proprietary or standard protocols etc. The protocol parameters 315 are preset quantities. The phone 300 after associating itself with the four access points, receives the protocol parameters 315 from corresponding access points. The phone 300 receives protocol parameter associated with the first protocol from the first access point upon association, receives protocol parameter associated with the second protocol from the second access point upon association and so on. In another embodiment the phone 300 upon association with an access point may receive a protocol identifier and a protocol version number from the access point and using the protocol identifier and the protocol version number retrieves the protocol parameter associated with corresponding protocol from a lookup table.

The current pathway performance parameters 317 corresponding to the four pathways from the phone 300 to the Internet backbone may comprise current performance of communication links between the phone 300 and immediate next network node along the four pathways i.e., the four access points. The current pathway performance parameters 317 comprise the current performance of four communication links between the phone 300 and the four access points i.e., the first wired link, the second wired link, the first wireless link and the second wireless link. The current pathway performance parameters 317 may include current data load on each of the four communication links, current noise and interference level in each of the four communication links, delay currently experienced by data packets in each of the four communication links, current cost of each of the four communication links, transmit power currently required at the phone 300 to maintain a predefined bit error rate on each of the four communication links etc. The current pathway performance parameters 317 at a first instant of time may be different from the same at a second instant of time. The phone 300 periodically updates the current pathway performance parameters 317 and replaces stored values of the pathway performance parameters in the storage system 309 with updated values.

The phone 300 may use the processing circuitry 303 of the phone to measure some or all of the current pathway performance parameters 317 periodically. The four access points may assist the phone 300 to measure the current pathway performance parameters 317 periodically. Alternately and/or in addition the phone 300 may receive current pathway performance parameters associated with a communication link from corresponding access point periodically. As an example the phone 300 may receive current pathway performance parameters associated with the first wired link from the first access point, the current pathway performance parameters associated with the second wired link from the second access point and so on.

The user preferences 319 received by the phone 300 via the plurality of buttons 331 (the user input interface of the phone 300) may comprise user identity, desirable downstream data rate, desirable cost, user preference for a protocol, user preference for a pathway etc. The user identity may identify a plurality of services that a user using the phone 300 may avail of.

The phone 300 transmits the four IP addresses (network addresses) 311 of the phone 300, the protocol parameters 315 associated with the four pathways, the current pathway performance parameters 317 corresponding to the four pathways and the user preferences 319 to each of the four access points, i.e., the first AP, the second AP, the third AP and the fourth AP. The first AP that belongs to the cable data network is aware that the phone 300 is additionally associated with the fiber optic data network, the satellite data network, and the UMTS network. The first AP knows unique IP addresses assigned by the fiber optic data network, the satellite data network, and the UMTS network to the phone 300. The first AP is not only aware of current performance of the first wired link between the phone 300 and the first AP, the first AP is further aware of current performance of the second wired link, the first wireless link and the second wireless link. The first AP is aware of capabilities and limitations of the fiber optic data network, the satellite data network, and the UMTS network. The first AP is thus made aware of all network associations of the phone 300 and related parameters and the user preferences of the phone 300. The second AP that belongs to the fiber optic data network is similarly aware that the phone 300 is additionally associated with the cable data network, the satellite data network, and the UMTS network. The second AP is made aware of the protocol parameters and the current pathway performance parameters associated with all network associations of the phone 300 and the user preferences set by the user. The phone 300 passes protocol parameters and current pathway parameters corresponding to a pathway between the phone 300 and the Internet backbone to all other pathways between the phone 300 and the Internet backbone.

At an instant the phone 300 may move to a location that is not serviced by the fourth AP. The phone 300 disassociates with the fourth AP. The phone 300 updates the protocol parameters and the current pathway performance parameters and sends updated protocol parameters and the current pathway performance parameters to each of currently associated access point. The updated protocol parameters comprise information corresponding to the first protocol, the second protocol, and the third protocol. The updated current pathway performance parameters comprise parameters associated with the first wired link, the second wired link, and the first wireless link. The phone 300 sends the first IP address, the second IP address, and the third AP address to each of the first AP, the second AP, and the third AP. The first AP, the second AP, and the third AP are thus made aware of disassociation of the phone 300 from the fourth access point.

At a subsequent instant of time the phone 300 may move to a different location that is serviced by a fifth AP that belongs to WiMax network. The phone 300 receives a fifth IP address from the fifth AP and stores in the storage system 309. The phone 300 collects and/or retrieves protocol parameters associated with the WiMax protocol and stores in the storage system 309. In addition the phone 300 gathers current pathway performance parameter associated with a fifth wireless link between the phone 300 and the fifth AP. The network addresses 311 at the subsequent instant of time refer to the first IP address, the second IP address, the third IP address, and the fifth IP address of the phone 300. The associated AP addresses 313 at the subsequent instant of time refer to different IP addresses that the first AP, the second AP, the third AP, and the fifth AP use to communicate with the phone 300. The protocol parameters 315 at the subsequent instant of time refer to information related to the first protocol, the second protocol, the third protocol, and the WiMax protocol. The current pathway performance parameters 317 at the subsequent instant of time refer to performance characteristics of the first wired link, the second wired link, the first wireless link, and the third wireless link at the subsequent instant of time. The user preferences 319 remains same if the user does not make fresh entries via the user input interface 331 of the phone 300 at the subsequent instant of time.

The phone 300 sends the network addresses 311, the protocol parameters 315, the current pathway performance parameters 317, and the user preferences 319 to each of associated access points at the subsequent instant of time. The each of associated access points at the subsequent instant of time i.e., the first AP, the second AP, the third AP, and the fifth AP are made aware of all other network associations of the phone 300 and parameters related to pathways between the phone 300 and the Internet backbone.

The phone 300 and/or associated access points at an instant of time may use the user preferences 319. For example, the user identity in the user preferences 319 may suggest that the user may only browse Web. If the user attempts to download an archived data, the processing circuitry 303 of the phone 300 and/or the associated access points may prevent the user from downloading the archived data at the instant of time. The desirable downstream data rate in the user preferences 319 may prompt the processing circuitry 303 of the phone 300 and/or the associated access points to direct received data packets via a pathway that supports the desirable downstream data rate from all available pathways at the instant of time. As another example, the desirable cost in the user preferences 319 may prompt the processing circuitry 303 of the phone 300 and/or the associated access points to direct data packets via another pathway that costs less than or equal to the desirable coat from all available pathways at the instant of time.

The processing circuitry 303 of the phone 300 may respond to a change in any of the network addresses 311, the protocol parameters 315, the current pathway performance parameters 317, and the user preferences 319 by updating the following parameters and sending updated parameters to currently associated access points. The processing circuitry 303 of the phone 300 may additionally update the network addresses 311, the protocol parameters 315, the current pathway performance parameters 317, and the user preferences 319 periodically and send updated parameters to currently associated access points.

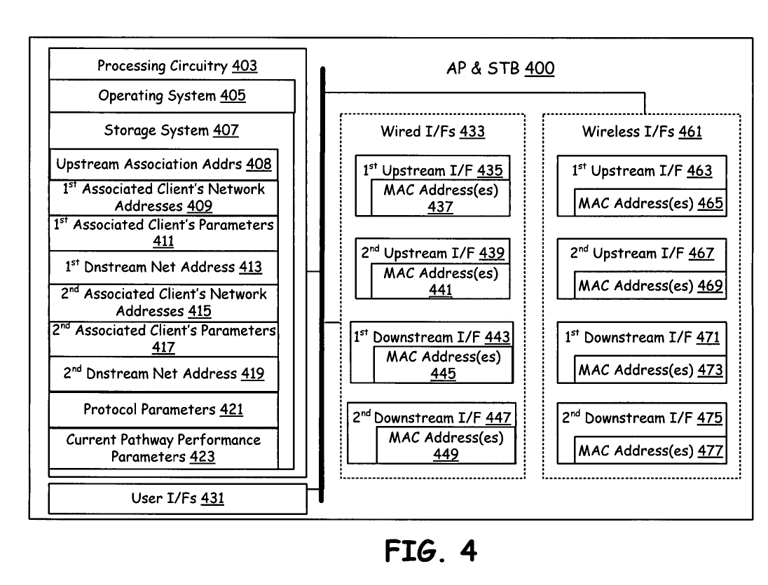

FIG. 4 is a schematic block diagram illustrating a plurality of components of an access point 155 of FIG. 1, the access point 155 supporting a plurality of packet switched data paths from the access point 155 to the Internet backbone 103. A set top box that is typically used with a television may support packet switched data transmission and reception and act as a transceiver, i.e., the set top box may carry data packets from a television to a server or a network node that belongs to a television channel service provider and vice versa. FIG. 2 illustrates the plurality of components that are common to the access point 155 of FIG. 1 and the set top box. The AP (access point) or the STB (set top box) 400 comprises a processing circuitry 403, a user input interface 431, a plurality of wired interfaces 433 and a plurality of wireless interfaces 461. The processing circuitry 403 comprises a storage system 407. The user input interface 431 may be a plurality of buttons, a touch screen, a voice based interface, a mouse, a thumbwheel, a screen and a pen, a touchpad etc. The plurality of wired interfaces 433 comprise a first wired upstream interface 435, a second wired upstream interface 439, a first wired downstream interface 443 and a second wired downstream interface 447. The plurality of wireless interfaces 461 comprise a first wireless upstream interface 463, a second wireless upstream interface 467, a first wireless downstream interface 471 and a second wireless downstream interface 475.

The upstream interfaces (wired upstream and wireless upstream interfaces) of the AP (or the STB) 400 support packet data communication between the AP (or the STB) 400 to one or more immediate next upstream network node and the downstream interfaces (wired downstream and wireless downstream interfaces) support packet data communication between the AP (or the STB) 400 and one or more immediate next downstream client devices. A network node may be a router, a switch, a modem etc. that participates in packet data transport from an originating device to a destination device. A client device is a terminal, an originating device and/or a destination device that runs a communication application that necessitates transmission and/or reception of packet data via the Internet backbone. Typical examples of the client device are a personal computer, a laptop, a phone, a PDA, a video game box, a server, a television, or any of a variety of terminals. The packet data may be an audio, a video, a picture, an email, a web page, a music video, a file stored in an Internet and/or Intranet server, a text message, a television program and any of a variety of multimedia information fragmented into packets. As an example a laptop may be running a Web browsing application (i.e., the communication application) that calls for retrieval of a web page from a storage server. In the example the laptop is the originating device; the storage server is the destination device. The laptop and the storage server may be also called as client devices. The laptop and the storage server (i.e., the client devices) are communicatively connected to the Internet backbone via typically more than one access points. The web page or information in the web page fragmented into packets travels from the storage server to the Internet backbone and then to the laptop. The access points to which the laptop and the storage server are communicatively connected may belong to same or a variety of industry standard or proprietary packet switched data networks such as fiber optic data network, cable data network, public switched telephone network, GSM network, CDMA network, EDGE network, UMTS network, IEEE 802.11 network, WiMax network, satellite data network etc. The information in the web page fragmented into packets may travel from the storage server to the laptop via a plurality of packet switched data networks that may be communicatively incompatible.

The AP (or the STB) 400 communicates with a first node that belongs to a fiber optic data network using the first upstream wired interface 435, with a second node that belongs to a cable data network using the second upstream wired interface 439, with a third node that belongs to an EDGE network using the first upstream wireless interface 463 and with a fourth node that belongs to a WiMax network using the second upstream wireless interface 467. The fiber optic data network, the cable data network, the EDGE network, and the WiMax network use different protocols for packet data transmission and reception. Each of the wired and wireless upstream interfaces (435, 439, 463 and 467) interacts with at least a corresponding hardware device in the AP (or the STB) 400, and the corresponding hardware device is uniquely identified by a medium access control (MAC) address. The corresponding hardware device typically comprises a transceiver. The AP (or the STB) 400 communicates with the first node, the second node, the third node and the fourth node using a first network address assigned by the fiber optic data network, a second network address assigned by the cable data network, a third network address assigned by the EDGE network and a fourth network address assigned by the WiMax network respectively. The first, the second, the third and the fourth network address i.e., network addresses 408 corresponding to upstream associations of the AP (or the STB) 400 are stored in the storage system 407 of the AP (or the STB) 400. The AP (or the STB) 400 communicates with the first node that belongs to the fiber optic data network via the first upstream wired interface 435 using the first network address.

The AP (or the STB) 400 has four downstream communication interfaces. The AP (or the STB) 400 may connect to a maximum of four downstream client devices at an instant of time. As an example the AP (or the STB) 400 interacts with a PC (personal computer) using the first wired downstream interface 463 and with a TV (television) using the second wired downstream interface 467. The AP (or the STB) 400 assigns a fifth network address to the PC and a sixth network address to the TV. In the example the AP (or the STB) 400 has only two downstream network associations. Each network association (upstream and downstream) between two devices is identified by a pair of unique network addresses, one each on the two devices. Association of the AP (or the STB) 400 with the PC is identified by the fifth network address assigned to the PC and a first downstream network address 413 belonging to the AP (or the STB) 400. Association of the AP (or the STB) 400 with the TV is identified by the sixth network address assigned to the TV and a second downstream network address 419 belonging to the AP (or the STB) 400. The AP (or the STB) 400 communicates with the PC via the first wired downstream interface 463 and using the fifth network address and the first downstream network address 413. The AP (or the STB) 400 communicates with the TV via the second wired downstream interface 467 and using the sixth network address and the second downstream network address 419. The AP (or the STB) 400 stores the first downstream network address 413 and the second downstream network address 419 in the storage system 409.

The PC to which the AP (or the STB) 400 is associated (i.e., communicatively connected) via the first wired downstream interface 463 has associations with one or more additional access points. The PC is assigned unique network addresses by each of the access points with which the PC is communicatively connected. The PC sends all the unique network addresses 409 assigned to it by each of its associated access points to the AP (or the STB) 400 via the first wired downstream interface 463. The AP (or the STB) 400 thus becomes aware of all network associations of the PC and corresponding network addresses 409 used by the PC. The TV to which the AP (or the STB) 400 is associated (i.e., communicatively connected) via the second wired downstream interface 467 has associations with one or more additional access points. The TV sends all unique network addresses 415 assigned to it by each of its associated access points to the AP (or the STB) 400 via the second wired downstream interface 467. The AP (or the STB) 400 comes to know about all network associations of the TV and corresponding network addresses 415 used by the TV. The AP (or the STB) 400 stores the network addresses 409 used by the PC and the network addresses 415 used by the TV in the storage system 407.

The PC gathers protocol related parameters corresponding to all of its network associations, current performance parameters corresponding to all of its network associations and user-defined parameters and transmits all above mentioned parameters 411 to the AP (or the STB) 400. The AP (or the STB) 400 stores PC parameters 411 received from the PC in the storage system 407. The AP (or the STB) 400 in addition receives protocol related parameters, current performance parameters and user-defined parameters corresponding to all network associations of the TV from the TV and stores the received TV parameters 417 in the storage system 407. The AP (or the STB) 400 may receive the PC parameters 411 and the TV parameters 417 periodically from the PC and the TV respectively. The AP (or the STB) 400 replaces stored values of the PC parameters 411 and the TV parameters 417 with currently received values.

The AP (or the STB) 400 has four upstream network associations, association with the first node that belongs to the fiber optic data network, association with the second node that belongs to the cable data network, association with the third node that belongs to the EDGE network and association with the fourth node that belongs to the WiMax network. The AP (or the STB) 400 collects protocol parameters corresponding to protocols that are used for packet data exchange between the AP (and the STB) 400 and associated nodes. The AP (or the STB) 400 stores the collected protocol parameters 421 in the storage system 407. The protocol parameters 421 may comprise version number, bandwidth requirement, available data rate, transmit power requirement, supported quality of service, security information corresponding to a protocol used in the fiber optic data network, a protocol used in the cable data network, a protocol used in the EDGE network and a protocol used in the WiMax network. In one embodiment the AP (or the STB) 400 may send the collected protocol parameters 421 to associated downstream client devices i.e., the PC and the TV. In the embodiment the PC and the TV receives the protocol related parameters corresponding to association with the AP (or the STB) 400 from the AP (or the STB) 400.

The AP (or the STB) 400 may collect current pathway performance parameters 423 corresponding to communication links between the AP (or the STB) 400 and the upstream associated nodes (i.e., the first node, the second node, the third node and the fourth node) and stores the collected current pathway performance parameters 423 in the storage system 407. The network addresses of the PC 409, the PC associated parameters 411, the network addresses of the TV 415, the TV associated parameters 417 are referred to as remote information of the AP (or the STB) 400. The upstream network association addresses 408, the first downstream network address 413, the second downstream network address 419, the protocol parameters corresponding to upstream associations 421 and the current pathway performance parameters corresponding to upstream associations 423 are referred to as local information of the AP (or the STB) 400.

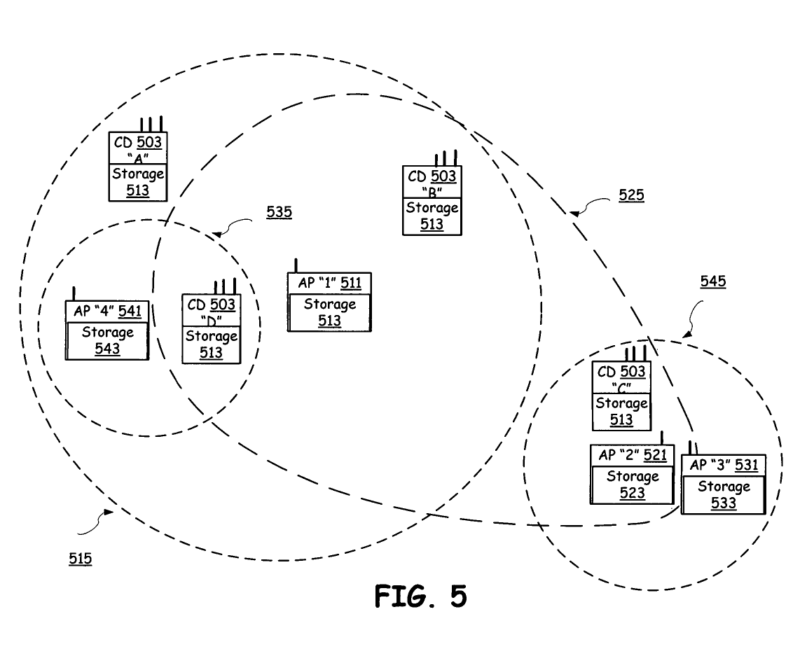

FIG. 5 is a schematic that shows a mobile client device 503 moving from coverage area of a first access point 511 to coverage area of a second access point 521. The mobile client device 503 comprises a storage unit 513 and a plurality of antennas and is adapted to communicate simultaneously with a plurality of access points. The mobile client device 503 at a first instant of time is located at a location “A”. The first access point 511 services the location “A”. The mobile client device 503 sets up a first communication association with the first access point 511. The first communication association is identified by a pair of unique network addresses, a first from the pair used by the mobile client device 503, and a second from the pair used by the first access point 511 for exchanging packet data with each other. The first access point 511 and all access points mentioned subsequently belong to packet switched communication network i.e., the all access points support packet data communication.

The mobile client device 503 collects parameters associated with the first communication association and sends the collected parameters to the first access point 511. The collected parameters may comprise for example, protocol information, pathway performance information and user preferences set by a user etc. As an example the mobile client device 503 moves from the location “A” towards a location “B”. Performance of a first wireless link between mobile client device 503 and the first access point 511 changes due to the movement of the mobile client device 503. Consequently the pathway performance information changes. The mobile client device 503 is adapted to respond to a change in the parameters associated with the first communication association by collecting the parameters again and sending most recently collected parameters to the first access point 511. The first access point 511 remains updated about the parameters associated with the first communication association between the first access point 511 and the mobile client device 503. The first access point 511 stores the parameters in a storage unit 513.

At a second instant of time the mobile client device 503 reaches the location “B”. The location “B” is served by the first access point 511 and the second access point 521. The first access point 511 and the second access point 521 may belong to communicatively incompatible packet switched data networks. Geographical areas 515 and 525 are respectively served by the first access point 511 and the second access point 521. The mobile client device 503 associates itself with the second access point 521 at the second instant of time, thus setting up a second communication association. A second wireless link is set up between the mobile client device 503 and the second AP 521. Unique network addresses assigned by the first access point 511 and the second access point 521 to the mobile client device 503 are referred to as a first network address and a second network address respectively.

The mobile client device 503 at the second instant of time collects parameters associated with the second communication association. The mobile client device 503 sends the second network address and the parameters associated with the second communication association to the first access point 511. The first access point 511 comes to know about the second communication association and performance and/or characteristics of the second communication association. In addition the mobile client device 503 sends the first network address and the parameters associated with the first communication association to the second access point 521. The second access point 521 is thus informed about the first communication association. The first access point 511 and the second access point 521 store received network address and parameters in respective storage units. The mobile client device 503 updates the first access point 511 and the second access point 521 about any change in the parameters. The mobile client device 503 stores the first network address, the second network address, the parameters associated with the first and the second communication association in the storage unit 513.

At a third instant of time the mobile client device 503 moves to a location “C”. The location “C” is served by the second access point 521 and a third access point 531. The mobile client device 503 dissociates itself from the first access point 511 and associates itself with the third access point 531 at the third instant of time. Dissociation from the first access point 511 results in the mobile client device 503 removing the first network address from the storage unit 513. The mobile client device 503 ceases to collect parameters associated with the first communication association after dissociating itself from the first access point 511. Association with the third access point 531 results in the mobile client device 503 receiving a third network address from the third access point 531. The mobile client device 503 starts collecting parameters associated with a third communication association with the third access point 531. The mobile client device 503 informs the second access point 521 about the third communication association and the performance and/or characteristics of the third association by sending the third network address the collected parameters corresponding to the third communication association to the second access point 521. By way of doing so the second access point 521 is also made aware of the dissociation of the mobile client device 503 from the first access point 511. Similarly the third access point 531 comes to know about associations (if any) of the mobile client device 503 with other access points.

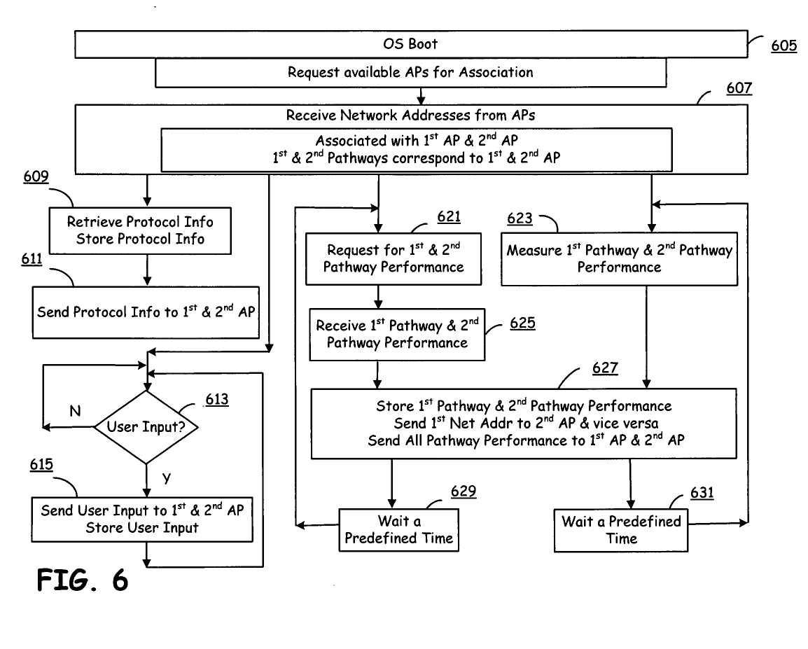

FIG. 6 is a flow chart illustrating a method of collecting information corresponding to a plurality of network associations of a client device by the client device. The client device may be a personal computer, a phone, a laptop, a television, a PDA that is capable of communicating with a packet switched data network. The packet switched data network may be a cable data network, a fiber optic data network, a satellite data network, a WiMax network, an IEEE 802.11 network, an UMTS network, a GPRS network, a CDMA network or any of a variety of standard or proprietary data network that carries data fragmented into packets. The data refers to one or more of a video, an audio, a music video, a video game, a voice conversation, a picture, a text message, a television program, and any live or archived multimedia information. The client device is turned on and an operating system (OS) of the client device (for e.g., Windows XP, Linux, UNIX etc.) starts booting in block 605. The client device searches for available access points. An access point is a transceiver that exchanges data packets between the client device and a packet switched data network. The client device may broadcast an association request and the available access points respond to the association request by sending unique network addresses to the client device. The client device receives a plurality of unique network addresses from the available access points. As an example and without limitation the client device receives a first network address from a first access point (AP) and a second network address from a second AP as shown in block 607. The client device is said to be associated with the first AP and the second AP and aforesaid two network associations of the client device are identified by the first network address and the second network address respectively. A first pathway is thus set up between the client device and an Internet backbone where a first communication link between the client device and the first AP and the first AP are part of the first pathway. Similarly a second pathway is set up between the client device and the Internet backbone where the second pathway comprises a second communication link between the client device and the second AP and the second AP. The client device sends and/or receives data packets from a destination device via the Internet backbone. The destination device is a second client device with which the client device desires to communicate. The data packets may travel from the client device to the destination device via either the first pathway or the second pathway or simultaneously via the first pathway and the second pathway. The first pathway and the second pathway may not be disjoint with each other, i.e., the first pathway and the second pathway may have one or more common communication links between them beyond the first AP and the second AP.

The client device after associating with the first AP and the second AP collects information associated with the first pathway and the second pathway. The information may comprise protocol related information, user-defined preferences and information corresponding to current performance of the first pathway and the second pathway. The protocol related information comprises limitations and capabilities of protocols that the client device uses for communicating separately with the first AP and the second AP. The client device may use two communicatively incompatible protocols for communicating separately with the first AP and the second AP. Information regarding the limitations and capabilities of the protocols used by the client device may typically be stored in a storage device. In block 609 the client device retrieves the protocol related information from the storage device and stores the retrieved protocol related information in a memory of the client device. In a next step 611 the client device sends the retrieved protocol related information to the first AP and the second AP.

The client device comprises a user input interface. The user input interface may be a plurality of buttons, a mouse, a touch screen, a touchpad, a pen etc. A user may enter user preferences via the user input interface of the client device. The user-defined preferences typically include a desirable data rate, preference for a protocol, preference for a pathway, maximum cost that user may avail etc. In a block 613 the client device checks if it has received a user input. If the client device receives a user input in the block 613 then the client device stores the received user input in a next block 615 and sends the received user input to the first AP and the second AP.

The client device while retrieving the protocol related information and awaiting the user input may simultaneously request the first AP, the second AP and/or any network node along the first pathway and the second pathway for the information regarding the current performance of the first pathway and the second pathway as shown in a block 621. The information regarding the current performance of each of the first pathway and the second pathway may typically include latency, traffic load, interference level, noise level, cost involved, transmit power requirement, error rate performance, offered level of security, coding and/or decoding requirement of corresponding pathway. The client device receives the information regarding the current performance of the first pathway and the second pathway in a next block 625. The client device stores the received pathway performance information in the memory of the client device as shown in a block 627. The client device sends the first network address to the second AP and the second network address to the first AP in the same block 627. The client device in addition sends the received information corresponding to current performance of the first pathway and the second pathway to each of the first AP and the second AP in the block 627. The first AP henceforth knows the second network address of the client device i.e., the network address assigned by the second AP to the client device, current performance of the first pathway and the second pathway. Similarly the second AP becomes aware of the first network address of the client device and the current performance of the first pathway and the second pathway. The client device waits for a predefined amount of time as shown in block 629 and jumps to the block 621. The client device again requests the first AP, the second AP and/or any network node along the first pathway and the second pathway for the information regarding the current performance of the first pathway and the second pathway.

The client device may alternately use its processing circuitry and communication interfaces to measure the current performance of the first pathway and the second pathway as shown in a block 623. The client device may perform the current performance measurement by sending a plurality of data packets, receiving corresponding echo, and analyzing the received echo. The client device jumps to the block 627 and performs all functionalities illustrated in the block 627. The client device stores the measured pathway performance information in the memory of the client device in the block 627. The client device sends the first network address to the second AP and the second network address to the first AP and in addition sends the received information corresponding to current performance of the first pathway and the second pathway to each of the first AP and the second AP in the block 627. The client device waits a predefined period of time as illustrated in a next block 631 and then jumps to the block 623. The client device updates performance information of the first pathway and the second pathway by measuring the performance of the first pathway and the second pathway again.

In the example the client device is associated with two access points, the first AP and the second AP. Number of access points with which the client device may associate itself simultaneously is limited by number of communication interfaces of the client device. The access points with which the client device associates itself simultaneously may belong to communicatively incompatible packet switched data networks. In the example associations of the client device remain same, i.e., the client device remains associated with the first AP and the second AP for all time.

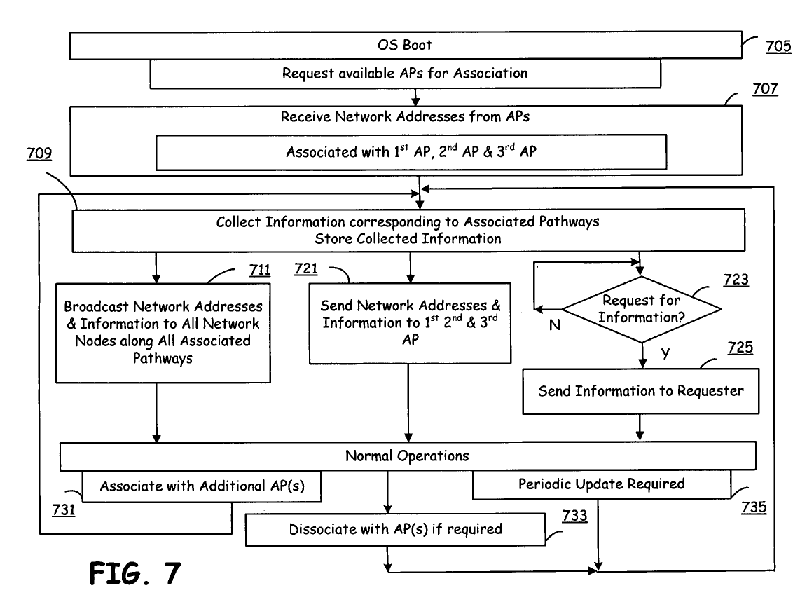

FIG. 7 is a flow chart illustrating functions performed by a client device that supports a plurality of network associations. In a block 705 an operating system of the client device starts booting as soon as the client device is powered on. The client device broadcasts a network association request in the same step 705. A plurality of access points may serve an area where the client device is located. The plurality of access points are transceivers that may belong to same or heterogeneous type of packet switched data networks. In the exemplary case a first AP (access point), a second AP, and a third AP serve the area where the client device is located. The first AP, the second AP and the third AP respond to the network association request by sending respectively a first network address, a second network address, and a third network address to the client device. The client device receives the first network address, the second network address, and the third network address in a next step 707. The client device thus gets associated with the first AP, the second AP, and the third AP in the step 707.

The client device may be a laptop, a PC, a television, a phone, a PDA, or any of a variety of terminals that is adapted to handle packet data communication. The client device comprises more than one radio using which the client device associates it with more than one access point. In this example the client device comprises at least three radios and is able to associate itself with the first AP, the second AP, and the third AP. At least one communication application for example, an Internet browsing application, a telephony application, a teleconferencing application, an archived file downloading application, a video gaming application etc. may be running on the client device. The at least one communication application calls for reception or transmission of data packets to at least one destination device. The destination device may be another laptop, PC, Internet and/or Intranet server, phone, television, or any of a variety of devices that is adapted to handle packet data communication. The data packets flowing between the client device and the destination device may contain archived and/or real-time information that may be one or combination of video, audio, text, picture, control information etc. The data packets from the client device flow to the destination device via a backbone network (i.e., Internet backbone) even if the client device and the destination device are associated with same access point. By way of association of the client device with the first AP, the second AP and the third AP, three pathways for delivery of the data packets are available, a first pathway via the first AP, a second pathway via the second AP and a third pathway via the third AP. The first pathway comprises a communication link between the client device and the first AP, the first AP and the backbone network. Similarly the second pathway comprises another communication link between the client device and the second AP, the second AP and the backbone network. If the packet switched data networks follow Internet protocol (IP) then the first network address, the second network address, and the network address are IP addresses.

In a next step 709, the client device collects information corresponding to the first pathway, the second pathway, and the third pathway. The client device may retrieve at least a portion of the information from one or more storage units. The client device may in addition receive at least another portion of the information from one or combination of the first AP, the second AP, the third AP, any node(s) along the first pathway, any node along the second pathway, and any node(s) along the third pathway. The client device may alternately or in addition measure the information corresponding to the first pathway, the second pathway, and the third pathway using a processing circuitry of the client device. The client device is adapted to receive at least yet another portion of the information from a user input interface of the client device. The client stores the collected information in a memory of the client device in the step 709.

The client device may broadcast the first network address, the second network address, the third network address, and the collected information to all nodes along each of the first pathway, the second pathway, and the third pathway as shown in a block 711. The client device may alternately send the first network address, the second network address, the third network address and the collected information to only the first AP, the second AP and the third AP as shown in a block 721. The client device may wait for a request for information and responds to the request from a requester (if the request comes) by sending the collected information to the requester as illustrated in steps 723 and 725.

The client device is adapted to respond to arrival of a fourth access point in the area where the client device is located by associating itself with the fourth access point. The client device needs to have a fourth radio in order to associate itself with the fourth access point. After discovering and associating with the fourth access point in step 731 the client device jumps back to the block 709 where the client device collects information corresponding to the first pathway, the second pathway, the third pathway and an additional pathway via the fourth access point.

The client device periodically updates its associations and information corresponding to currently associated pathways. The client device broadcasts the network association request periodically thereby ensuring that the client device remains associated with all available access points at an instant of time. The client device periodically collects information corresponding to currently associated pathways and stores the collected information in the memory of the client device as illustrated by block 735.

The client device is also adapted to respond to absence of an access point at an instant of time, with which the client device was hitherto associated, from the area where the client device is located. The client device responds to such a situation by dissociating itself from the access point that is absent at the instant of time. Dissociation prompts the client device to jump to the step 709 and collect information corresponding to currently associated pathways. Network address assigned by the absent access point to the client device and information corresponding to pathway associated with the absent access point gets erased from the memory of the client device after the step 709.

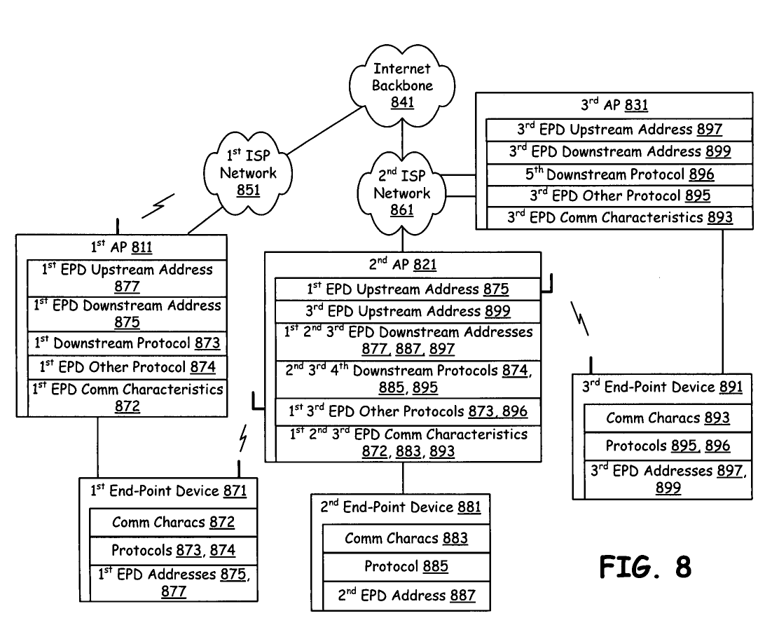

FIG. 8 is a schematic block diagram illustrating storage of a plurality of network addresses in each of a plurality of access points 811, 821 and 831 that interact with a plurality of end point devices 871, 881, and 891. A first end point device (EPD) 871 is communicatively connected to a first access point (AP) 811 via a first wired link and communicatively connected to a second AP 821 via a first wireless link. A second EPD 881 communicates with the second AP 821 via a second wired link. A third EPD 891 interacts with the second AP 821 via a second wireless link and interacts with a third AP 831 via a third wired link. The first AP 811 is communicatively coupled to Internet backbone 841 via a first Internet Service Provider (ISP) network 851. The second AP 821 and the third AP 831 are communicatively connected to the Internet backbone 841 via a second ISP network 861. Each of the first ISP network 851 and the second ISP network 861 may support one or more of a variety of protocols for packet data transfer such as IEEE 802.11 protocol, WiMax protocol, EDGE protocol, GPRS protocol, WCDMA protocol etc. Each of the end point devices 871, 881 and 891 are adapted to communicate with each other via respective access point, respective ISP network and the Internet backbone 841. As an example the first EPD 871 may send and receive data packets from the second EPD 881 via the second AP 821, the second ISP network 861, the Internet backbone 841, the first ISP network 851 and the first AP 811. Each of the end point devices 871, 881, and 891 may be a laptop, a personal computer, a phone, a PDA, a television or any of a variety of devices that are adapted to handle packet switched data.

Each of the end point devices 871, 881 and 891 use unique network addresses to communicate with corresponding access point(s). As an example the first EPD 871 and the first AP 811 exchange data packets that are encapsulated with a downstream network address 875. “Downstream network address” refers to a network address used by an AP (811, 821 or 831) to communicate directly with an EPD (871, 881 or 891). The first EPD 871 and the second AP 821 use downstream network address 877 to exchange data packets between them. The first EPD 871 stores the downstream network addresses 875 and 877 in a memory of the first EPD 871. The first EPD 871 may use same or different protocols to communicate respectively with the first AP 811 and the second AP 821. The first EPD 871 and the first AP 811 store information related to a protocol 873 that they use for packet data communication in respective memories. The information related to protocol 873 may comprise a protocol identifier, version number, maximum data rate supported by the protocol, security information, QoS provided by the protocol etc. The first EPD 871 and the second AP 821 store information related to protocol 874, which is used by the first EPD 871 and the second AP 821 during direct packet data communication between them, in respective memories. The first EPD sends the protocol related information 874 to the first AP 811 for storage. The first AP 811 is made aware of the information related to the protocol that the first EPD 871 uses for communicating with the second AP 821. The first EPD in addition sends the protocol related information 873 to the second AP 821 to make the second AP 821 aware of information related to the protocol used for packet data communication between the first AP 811 and the first EPD 871.

The first EPD 871 sends the network address 877 to the first AP 811. The first AP 811 is not adapted to use the network address 877 to communicate directly with the first EPD 871 along downstream direction. The first AP 811 stores the network address 877, which is used by the second AP 821 for downstream communication with the first EPD 871, in a memory of the first AP 811. The network address 877 is referred as first EPD upstream address to indicate that the first AP 811 may use the network address 877 for packet data communication along upstream direction. “Upstream network address” refers to a network address used by an AP (811, 821 or 831) to send and/or receive data packets from a network node other than an EPD (871, 881 or 891). The first EPD sends the network address 875, which is used by the first AP 811 for downstream communication with the first EPD 871, to the second AP 821. The network address 875 is referred to as first EPD upstream address to indicate that the second AP 821 may use the network address 875 for packet data communication along upstream direction. The first AP 811 is communicatively associated with the first EPD 871 and the first AP 811 stores all network addresses of the first EPD 871 corresponding to all network associations of the first EPD 871.

The first EPD 871 collects communication characteristics corresponding to two communication links the first EPD 871 has with the two access points, the first wired link with the first AP 811, and the first wireless link with the second AP 821. The first EPD 871 stores the collected communication characteristics 872 in the memory of the first EPD 871. The first EPD 871 sends the collected communication characteristics 872 to all access points with which the first EPD 871 is associated. In this exemplary case the first EPD 871 sends the collected communication characteristics 872 to each of the first AP 811 and the second AP 821. The first AP 811 and the second AP 821 store the communication characteristics 872 in respective memories. The communication characteristics 872 may, for example, comprise current performance of the first wired link and the first wireless link, such as current traffic load, noise and/or interference level, delay, cost etc. of each of the first wired link and the first wireless link. The first EPD 871 may collect and send the communication characteristics 872 periodically to keep the first AP 811 and the second AP 821 updated about the performance of the first wired link and the first wireless link. The first AP 811 is made aware of performance of communication links between the first EPD 871 and all associated access points (i.e., the first AP 811 and the second AP 821). Similarly the second AP 821 is made aware of performance of the communication links between the first EPD 871 and all associated access points (i.e., the first AP 811 and the second AP 821).

The second AP 821 is communicatively associated with the first EPD 871, the second EPD 881, and the third EPD 891. The second AP 821 may use one or more packet switched data protocols to communicate with associated end point devices, 871, 881, and 891. In this exemplary case the first wireless link between the second AP 821 and the first EPD 871 may typically support packet data communication using IEEE 802.11 protocol. The second wired link between the second AP 821 and the second EPD 881 may typically support fiber optic data protocol and the second wireless link between the third EPD 891 and the second AP 821 may again support IEEE 802.11 protocol. Network addresses of the first EPD 871, 875 and 877 are available with the second AP 821. The second EPD 881 communicates with the second AP 821 using network address 887. The second EPD 881 collects communication characteristics 883 corresponding to the second wired link. The second EPD 881 stores the communication characteristics 883 in a memory of the second EPD 881 and also sends the communication characteristics 883 to the second AP 821 for storage in the second AP 821. Protocol related information 885 is stored in the second AP 821 and in the second EPD 881. The protocol related information 885 may comprise maximum data rate supported by the fiber optic data protocol, security information, QoS provided by the fiber optic data protocol etc.

The third EPD 891 is communicatively connected to the second AP 821 and the third AP 831. The third EPD 891 uses network address 897 and 899 to exchange data packets with the second AP 821 and the third AP 831 respectively. The network address 897 is referred to as third EPD downstream address of the second AP 821 and the network address 899 is referred to as third EPD downstream address of the third AP 831 as the network addresses 897 and 899 are respectively used for downstream communication of the second AP 821 and the third AP 831 with the third EPD 891. The third EPD 891 sends the network address 899 to the second AP 821. The network address 899 is stored as third EPD upstream address in the second AP 821 as the second AP 821 is not adapted to use the network address 899 for downstream communication with the third EPD 831. The second AP 821 may use the network address 899 for upstream communication with a node (i.e., a server, a switch, a router etc.) other than any of the end point devices 871, 881 and 891. The third EPD 891 sends the network address 897 to the third AP 831. The network address 897 is stored as third EPD upstream address in the third AP 831 and the third AP 831 may use the network address 897 for upstream communication with an upstream node and not for downstream communication with any of the end point devices 871, 881 and 891.

The third EPD 891 collects communication characteristics 893 corresponding to the second wireless link and the third wired link and sends the communication characteristics 893 to each of the second AP 821 and the third AP 831. Each of the third EPD 891, the second AP 821 and the third AP 831 store protocol related information 895 and 896 in respective memories. The protocol related information 895 might typically comprise maximum data rate supported and QOS provided by the IEEE 802.11 protocol. The protocol related information 896 may typically comprise maximum data rate supported and QOS provided by a PSTN data network that is used for packet data communication over the third wired link between the third AP 831 and the third EPD 891. The second AP 821 has network addresses (875, 877, 887, 897, 899), communication characteristics (872, 883, 893) and protocol related information (873, 874, 885, 895, 896) corresponding to all network associations of all end point devices to which the second AP 821 is associated (871, 881, 891) stored in the memory of the second AP 821.

In another embodiment, all or some of the network addresses (875, 877, 887, 897, 899), the communication characteristics (872, 883, 893) and the protocol related information (873, 874, 885, 895, 896) may be stored in all or some of upstream nodes of the second ISP network 861 that lie on way from the second AP 821 to the Internet backbone 841.

The access points, i.e., the first AP 811, the second AP 821, and the third AP 831 may use the network addresses (875, 877, 887, 897, and 899), the communication characteristics (872, 883, and 893), and the protocol related information (873, 874, 885, 895, and 896) received from respective end point devices (871, 881, and 891) for performing various functionalities. The first EPD 871, the second EPD 881, and the third EPD 891 may in addition use the communication characteristics (872, 883, and 893) and the protocol related information (873, 874, 885, 895, and 896) collected by the end point devices 871, 881, and 891 for performing additional functionalities.

The first AP 811 communicates directly with the first EPD 871 using the first EPD downstream network address 875 and via the first wired link between the first EPD 871 and the first AP 811. The second AP 821 communicates directly with the first EPD 871 using the first EPD upstream network address 877 and via the first wireless link between the second AP 821 and the first EPD 871. The first AP 871 stores the first EPD downstream network address 875 and the first EPD upstream network address 877 in the memory of the first AP 871. The first AP 871 uses the first EPD upstream network address 877 to communicate indirectly with the first EPD 871 via the second AP 821 if the first AP 811 is unable to and/or does not desire to communicate directly with the first EPD 871. The first EPD 871 encapsulates data packets that it sends directly to the first AP 811 with the first EPD downstream network address 875. Similarly the first AP 811 encapsulates data packets that it sends directly to the first EPD 871 using the first EPD downstream network address 875. As an example, at an instant of time the first AP 811 may not be able to send the data packets destined for the first EPD 871 directly to the first EPD 871. This may happen due to a fault in the first wired link and/or no response from the first EPD 871, which may be in a sleep/inactive mode. The first AP 811 may be adapted to encapsulate the data packets destined for the first EPD 871 with the first EPD upstream network address 877 and transmit the encapsulated data packets to immediate next upstream network node via an upstream communication link. The immediate network node sends the encapsulated data packets to the Internet backbone 841 that broadcasts the encapsulated data packets. The encapsulated data packets eventually reach the second AP 821. The second AP 821 deciphers the encapsulated data packets and forwards the encapsulated data packets to the first EPD 871. The data packets destined for the first EPD 871 eventually reaches the first EPD 871 from the first AP 881 via the second AP 821. Each of the access points 811, 821 and 831 uses other network addresses of associated end point devices to send data packets to associated end point devices via other access points as and when required.

Each of the first EPD 871 and the third EPD 891 has more than one possible available communication pathways to any other EPD, server or other network device. The first EPD 871 has two upstream pathways via the first AP 811 and the second AP 821. The third EPD 891 has two upstream pathways, via the second AP 821 and via the third AP 831. To manage communication among the available plurality of upstream pathways, each of the first EPD 871 and the third EPD 891 employs multi-path management functionality through a combination of general and/or specific purpose hardware and associated software. Similarly, each of the first AP 811 and the third AP 831 both have two upstream communication pathways to respective ISP networks through which other terminals, servers and other network devices can be reached. The second AP 821 has three downstream communication pathways, via the first EPD 871, via the second EPD 881 and the third EPD 891. To manage communication among the available plurality of upstream and downstream pathways, each of the first AP 811, the second AP 821 and the third AP 831 also employ multi-path management functionality through a combination of general and/or specific purpose hardware and associated software. Likewise, any other network device having two or more upstream or two or more downstream pathways, such as servers that are part of the first ISP network 851 and/or the second ISP network 861 may employ the multi-path management functionality.

As used herein, “upstream pathway” and “downstream pathway” do not refer to actual direction of data flow. Instead, “upstream pathway” refers to a pathway from the present device that communicatively couples with the Internet backbone 841, while “downstream pathway” refers to a pathway from the present device toward an EPD. Thus, for example, the first AP 811 has two upstream pathways (both relevant to the first EPD 871). The second AP 821 has three downstream pathways (only one relevant to the first EPD 871). An “end point node” or “end point device” as used herein refers to any network device that is the original source or destination of a communication flow, such as a client device or a server.

Specifically, each network device having multiple upstream and/or multiple downstream pathways executes a multi-path management software application. Thus, in available pathways between two end-point devices, there may be one or a plurality of multi-path management applications running. Where there is only one, the multi-path management application operates to select a single pathway from among the available upstream and downstream pathways to support exchange of data packets between the two end-point devices. This selection may involve one or more upstream pathways and/or one or more downstream pathways. For example a communication application such as Internet telephony is running on the first EPD 871 and also on the third EPD 891. A communication pathway need to be set up between the first EPD 871 and the third EPD 891 to transport data packets from the first EPD 871 to the third EPD 891 and vice versa. In this exemplary case, there exists a plurality of pathways between the first EPD 871 and the third 891. For example, a first pathway from the first EPD 871 to the third EPD 891 is via the first AP 811, the first ISP network 851, the Internet backbone 841, the second ISP network 861 and the third AP 831. A second pathway from the first EPD 871 to the third EPD 891 is via the first AP 811, the first ISP network 851, the Internet backbone 841, the second ISP network 861 and the second AP 821. A multi-path management application running on the first EPD 871 selects a single pathway from among the plurality of pathways between the first EPD 871 and the third 891 and directs flow of the data packets along the selected pathway. Others of the upstream and downstream pathways may be maintained in an inactive state, or used to support other end-point device exchanges.

When a plurality of multi-path applications exist in an overall pathway between two end-point devices, each will operate pursuant to local settings. For example, depending on the network configuration and local settings and with or without support from any upstream multi-path application, each multi-path management application may independently manage its upstream pathways but not downstream. Alternatively, based on settings, all or a portion of the overall management process can be centralized to one multi-path application with the others entering a dormant state or taking on a supporting role. Likewise, all or some of the multi-path management applications may operate in concert to manage a data exchange between any two end-point devices. As an example, in addition to a first multi-path management application running on the first EPD 871, a second multi-path management application running on the first AP 811 and a third multi-path management application running on the third EPD 891 may cooperate to select the first pathway from among the plurality of pathways between the first EPD 871 and the third EPD 891 and direct flow of the data packets along the selected first pathway. Alternately the first multi-path management application may select the first pathway from among the plurality of pathways between the first EPD 871 and the third EPD 891 and the second multi-path management application and the third multi-path management application may assist in transportation of the data packets along the selected first pathway.

Pathway selection may be performed, for example: 1) upon powering up an EPD; 2) as pathway (communication) characteristics change; 3) as pathways change or become available; 4) as demands change; 5) periodically or continuously; 6) as the communication requirements of local or remote communication software applications change, etc. Selection may be for all communication involving, for example: a) the end-point device; b) a particular communication software application; c) a particular media type; and/or d) on a request by request basis.

As an example, the first EPD 871 (or a user using the first EPD 871) desires to send (upstream) data to a destination terminal connected to the Internet backbone 841. The first multi-path management application running on the first EPD 871 evaluates and chooses one of the two available upstream pathways to conduct one or ongoing communication exchanges. Alternatively, if so configured, the first multi-path management application running on the first EPD 871 might merely evaluate (or assist in evaluating) the two available upstream pathways and send related information and results to the first AP 811. The second multi-path management application running on the first AP 811 responds by evaluating the received information and results and, based thereon, instructs the first EPD 871 to use the network address 877 and the second AP 821 to connect to the Internet backbone 841.

For example, the first pathway from the first EPD 871 to the third EPD 891 via the first AP 811, the first ISP network 851, the Internet backbone 841, the second ISP network 861 and the third AP 831 is selected for exchange of data packets between the first EPD 871 and the third EPD 891. The first EPD 871 exchanges the data packets with the first AP 811 via the first wired link selected by the first multi-path management application running on the first EPD 871, and the first AP 811 exchanges the data packets with the first ISP network 851 pursuant to instructions from a fourth multi-path management application running on a first ISP server. Many other variations are contemplated, such as differing pathways based on data flow, e.g., pathways from the first EPD 871 to the second EPD 881 might involve different multi-path management responsibilities and resulting pathway selection than that from the second EPD 881 to the first EPD 871. A communication pathway from the first EPD 871 to the second EPD 881 might involve each EPD making its own, independent assessment and selection of one or more of its links that lead to the second EPD 881. Likewise, in a communication pathway from the second EPD 881 to the first EPD 871, each device may only make its own, independent assessment and selection of one or more of its links that lead to the first EPD 871.

When responsible to do so, a multi-path management application evaluates a plurality of communication characteristics and protocol related information for each available upstream and downstream link. Based on such characteristics and information, the multi-path management application generates a link rating for each link that comprises one or more factors. By comparing the one or more factors of the first and second link ratings, the multi-path management application can determine which of the available links in a pathway to use.

The plurality of characteristics and information may include maximum and current bandwidth, loading, queue backlogs, competing demands, data types, interference, error rates, security, link billing costs, etc. In particular, some of the plurality of characteristics is time invariant and others vary with time. For example, those that vary over time may do so because of changes in bandwidth, pathway routing, network load, QoS (Quality of Service), transmission power requirements, error rate, roaming, etc. Some characteristics that may not vary over time include, for example, link billing costs, maximum bandwidth, QoS guarantees, robustness of a link against eavesdropping, circuit vs. packet switched characteristics, etc.

After an initial evaluation and selection of a communication pathway between, for example, the first EPD 871 and the third EPD 891 for supporting an Internet telephony application, the first multi-path management application running on the first EPD 871 may reevaluate its decision at regular intervals, whenever new demands are placed on the link, and whenever another change occurs that exceeds some preset threshold. If a more appropriate configuration is warranted, the first multi-path management application may direct link changes in accommodation. This may happen, for example, due to an increase in amount of data required by the third EPD 871 that opens a second window to display a video stream, or due to another data exchange ending and freeing up a more desirable link path. Alternatively, a large amount of data may be waiting at the first EPD 871 for upstream delivery at a subsequent instant of time. Using a currently active link for such delivery may place immediate loading on the link that exceeds total load the currently active link can sustain. In response, the first multi-path management application running on the first EPD 871 might select another pathway that can sustain the increased traffic load. The first multi-path management application reroutes delivery of all packet data via the newly selected pathway.

The multi-path management application(s) seamlessly switches data transportation from one communication pathway (link) to another with or without the end point devices and/or the communication application running on the end point devices being notified. For example, the EPD 871 may be unaware of the fact that the packet data generated by the EPD 871 reaches the third EPD 891 via the third AP 831. The first EPD 871 and the third EPD 891 may be kept unaware of switching performed by the first multi-path management application from the first pathway between the first EPD 871 to the third EPD 891 to the second pathway between the first EPD 871 to the third EPD 891. The switching of data transportation from the first pathway to the second pathway does not hamper flow of data, generated by the first EPD 871 and/or data generated by the second EPD 891.

To manage communication via multiple possible paths to the Internet backbone 841 from a communication application that is running on one of the end point devices, each of the end-point devices, access points and other types of network nodes employs multi-path management functionality through a combination of general and/or specific purpose hardware and associated software. As an example, a video game application is running on the first EPD 871. The video game application calls for a high bandwidth and low latency pathway from the first EPD 871 to a video game server that is communicatively coupled to the Internet backbone 841. The first multi-path management application running on the first EPD 871 may independently decide which of the two available pathways, one via the first AP 811 and second via the second AP 821, to be used for exchange of data packets corresponding to the video game application. In another embodiment, the first multi-path management application may cooperate with the local communication application i.e., the video game application to select a pathway from the two available pathways. The first multi-path management application and other multi-path management applications running on other network nodes may jointly select the pathway from the two available pathways. The multi-path management application(s) select the pathway using the communication characteristics (872, 883, and 893) and/or the protocol related information (873, 874, 885, 895, and 896) collected by the end point devices and sent to the other upstream network nodes.

The multi-path management application(s) depending on data types and data requirements also supports selection and maintenance of two or more paths that simultaneously serve a single communication application. For example the first multi-path management application may select a first path via the first AP 811 and a second path via the second AP 821 and may direct transport of a portion of the data packets corresponding to the video game application via the first path and direct transport of remaining portion of the data packets corresponding to the data packets via the second path. The first multi-path management application may alternately pass all or a portion of multi-path management responsibility to the local communication application i.e., the video game application running on the first EPD 871. The first multi-path management application running on the first EPD 871 may pass all or a portion of the multi-path management responsibility to other multi-path management application/s running on other network node/s.

The multi-path management application(s) in addition is adapted to seamlessly switch pathways as may become necessary to meet changing network conditions or bandwidth demands. Changing network conditions and bandwidth demands are reflected in the communication characteristics (872, 883, and 893) and/or in the protocol related information (873, 874, 885, 895, and 896). In this exemplary case, the first multi-path management application running on the first EPD 821 directs flow of the data packets corresponding to the video game application simultaneously via the first path and the second path. The first path comprises the first wired link between the first EPD 871 and the first AP 811, the first AP 811, a wireless link between the first AP 811 and the first ISP network 851. The second path comprises the first wireless link between the first EPD 871 and the second AP 821, the second AP 821, a wired link between the second AP 821 and the second ISP network 861. At an instant of time the first multi-path management application running on the first EPD 871 decides to use a wired link between the first AP 811 and the first ISP network 851 for packet data exchange instead of the wireless link between the first AP 871 and the first ISP network 851. The first multi-path management application performs the switching seamlessly and without hampering the flow of data between the first EPD 871 and the video game server and the flow of data along the second path. The first multi-path management application may or may not inform the video game application about the switching of paths.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A packet switched communication infrastructure comprising:
a backbone network supporting packet switched communication;
a first service provider network communicatively coupled to the backbone network;
a second service provider network communicatively coupled to the backbone network;
a first wireless area network operating pursuant to a first wireless protocol;
a second wireless area network operating pursuant to a second wireless protocol that is communicatively incompatible with the first wireless protocol;
a first access point, communicatively coupled to the first service provider network, that manages the first wireless area network;
a second access point, communicatively coupled to the second service provider network, that manages the second wireless area network;
an end-point device having a first network identifier for communicating via a first pathway, the first pathway comprising the first wireless network, the first access point, the first service provider network, and the backbone network;
the end-point device having a second network identifier for communicating via a second pathway, the second pathway comprising the second wireless network, the second access point, the second service provider network, and the backbone network; and
the client device wirelessly transmitting at least one parameter associated with the first pathway to the second access point, the at least one parameter comprising the first network identifier.

2. The communication infrastructure of claim 1, wherein the at least one parameter also comprising a usage parameter associated with the first pathway.

3. The communication infrastructure of claim 1, wherein the at least one parameter also comprising a first protocol parameter associated with the first wireless protocol.

4. The communication infrastructure of claim 1, wherein the at least one parameter also comprising a first user parameter associated with at least the first pathway.

5. A client device that communicates with a plurality of access points, each of the plurality of access points associated with a corresponding plurality of network nodes, each of the plurality of access points managing a local area network, the client device comprising:
a plurality of communication interfaces, each of the plurality of communication interfaces having at least one unique network address delivered through a corresponding one of the plurality of access points;
a storage system that stores a plurality of unique network addresses delivered by the plurality of access points;
a user input interface that receives user input identifying user preference;
a processing circuitry; and
the processing circuitry directing the plurality of communication interfaces to transmit the plurality of unique network addresses to each of the plurality of access points.

6. The client device of claim 5, wherein each of the plurality of communication interfaces further has an associated protocol parameter, the protocol parameter corresponds to a communication protocol used by the one of the plurality of communication interfaces to communicate with corresponding access point from the plurality of access points; and
the processing circuitry directs each of the plurality of communication interfaces to transmit the associated protocol parameter to each of the plurality of access points.

7. The client device of claim 5, the processing circuitry further directing the plurality of communication interfaces to transmit the user input to each of the plurality of access points.

8. The client device of claim 5, the storage system further storing the user input received by the user input interface.

9. The client device of claim 5, the processing circuitry further measures performance associated with each of the plurality of communication interfaces;
the storage system storing the measured performance; and
the processing circuitry directing the plurality of communication interfaces to transmit the measured performance to each of the plurality of access points.

10. A method performed by a client device that interacts with a plurality of access points and an additional access point, each of the plurality of access points and the additional access point managing a wireless local area network, the method comprising:
receiving a plurality of unique network addresses corresponding to the plurality of access points;
receiving an additional unique network address corresponding to the additional access point; and
sending the additional unique network address to each of the plurality of access points.

11. The method of claim 10 further comprising:
storing the additional unique network address in a memory of the client device.

12. The method of claim 10 further comprising:
searching for any additional access point periodically.

13. The method of claim 10 further comprising:
collecting a first network information corresponding to a first plurality of packet switched networks to which the additional access point is communicatively coupled; and
collecting second network information corresponding to a second plurality of packet switched networks to which the plurality of access points are communicatively coupled.

14. The method of claim 13 further comprising:
sending the first network information to each of the plurality of access points; and
sending the second network information to the additional access point.

15. The method of claim 13, wherein the first plurality of packet switched networks follow a first protocol that is communicatively incompatible with a second protocol followed by the second plurality of packet switched networks.

16. The method of claim 13 further comprising:
collecting the first network information corresponding to the first plurality of packet switched networks from the additional access point.

17. The method of claim 13 further comprising:
collecting the second network information corresponding to the second plurality of packet switched networks from the plurality of access points.

18. The method of claim 13 further comprising:
collecting the first network information and the second network information regularly.
